(19) United States
(12) Patent Application Publication
(10) Pub. No.: US 2026/0347155 A1
(43) Pub. Date: Nov. 5, 2026

(54) CRANE

(71) Applicant: TADANO LTD., Kagawa (JP)

(72) Inventors: Kei MIYOSHI, Kagawa (JP); Taku TSURUOKA, Kagawa (JP); Etsuo YAMAZAKI, Kagawa (JP)

(73) Assignee: TADANO LTD., Kagawa (JP)

(21) Appl. No.: 19/102,859

(22) PCT Filed: Oct. 19, 2023
(86) PCT No.: PCT/JP2023/037931

§ 371 Date: Feb. 11, 2025

(30) Foreign Application Priority Data
Oct. 20, 2022 (JP) 2022-168391

(51) Int. Cl. B66C 23/94; B66C 23/90

(52) U.S. Cl. CPC B66C 23/94; B66C 23/905

(57) ABSTRACT

This crane includes: a turning body; a boom that is supported by the turning body; a winch that winds and unwinds a wire rope supported on the boom; and a control device that controls the turning body, the boom, and the winch. The control device limits movement of the turning body, the boom, and the winch on the basis of competency-related information indicating the competency of an operator with respect to at least one type of work from among work for hoisting a suspended load, work for horizontally transporting the suspended load, and work for lowering the suspended load.

### Technical Field

The present invention relates to a crane.

### BACKGROUND ART

Conventionally, when a mobile crane is used to transport a suspended load, an operator of the mobile crane operates a plurality of operation implements such as an operation implement for slewing, an operation implement for derricking, an operation implement for telescopic movement, and an operation implement for winch.

In addition, the operator simultaneously operates the plurality of operation implements to operate the mobile crane while paying attention to prevent the suspended load from coming into contact with a structure in a work site, for example. Furthermore, the operator adjusts a position of the suspended load that swings due to a change in posture and a change in speed, for example, of the boom.

Therefore, competency of the operator operating the mobile crane greatly affects a period of time the mobile crane transports the suspended load and handling of the suspended load including content of transportation work.

For example, when competency required for work for transporting a suspended load by the mobile crane exceeds competency of the operator, there is a high possibility that the operator is not able to transport the suspended load to a predetermined position within an appropriate period of time. Then, there is known an operation support device capable of estimating competency of an operator to provide operation support suitable for the competency of the operator. For example, Patent Literature 1 is exemplified.

The operation support device for an operator, which is described in Patent Literature 1, includes an operation technique level estimation means that estimates competency (an operation technique level) representing a degree of proficiency of the operator and a degree of difficulty of work.

The operation technique level estimation means estimates competency of the operator based on a stop time that is a time until swinging of a suspended load is attenuated to a predetermined value or less during a transportation operation by the crane and a difference between an operation instruction value calculated based on a swing angle of the suspended load and an operation amount of an operation lever actually operated by the operator.

The operation support device for the operator instructs an appropriate operation amount for the operation lever to the operator based on the estimated operation technique level.

### Citation List

### Patent Literature

Patent Literature 1: JP 11-79663 A

### SUMMARY OF THE INVENTION

### Problems to Be Solved by the Invention

The operation support device instructs an appropriate operation amount for an operation lever to an operator based on an estimated operation technique level of the operator. However, there is a possibility that the operator feels a psychological and physical burden that it is impossible to appropriately operate the crane unless an operation lever is operated at an instructed operation timing and an instructed operation amount, for example.

In addition, work for transporting a suspended load by the crane includes a hoisting step for hoisting the suspended load placed on a ground, a transport step for transporting the suspended load in a hoisted state, and a grounding step for lowering the suspended load at a predetermined position.

Therefore, in estimating an operation technique level of competency of an operator based only on an operation technique for suppressing swinging of a suspended load, there have been cases where the operation technique level of the operator is not appropriately estimated.

An object of the present invention is to provide a crane that is able to be operated within a range in which it is possible to reduce a psychological and physical burden on an operator when the operator operates the crane, based on appropriately evaluated competency of the operator.

### Solutions to Problems

One aspect of a crane according to the present invention includes:
a turning body;
a boom that is supported by the turning body; a winch that winds and unwinds a wire rope supported on the boom; and
a control device that controls the turning body, the boom, and the winch,
in which the control device limits movement of the turning body, the boom, and the winch based on competency-related information indicating competency of an operator, the competency being related to at least one type of work from among work for hoisting a suspended load, work for horizontally transporting the suspended load, and work for lowering the suspended load.

### Effects of the Invention

According to the present invention, it is possible to evaluate in more detail competency of an operator in each of steps including a hoisting step for a suspended load, a transport step for the suspended load, and a grounding step for the suspended load, which require different competency in handling of the suspended load.

### BRIEF DESCRIPTION OF DRAWINGS

FIG. 1 is a side view of a crane according to a first embodiment of the present invention.

FIG. 2 is a control block diagram of the crane according to the first embodiment of the present invention.

FIG. 3 is a route diagram illustrating a hoisting step, a transport step, and a grounding step for which evaluation is to be performed by utilizing a competency-related information generation model that the crane according to the first embodiment of the present invention includes.

FIG. 4 is a graph illustrating a relationship between an operation amount of an accelerator pedal and a number of rotations of a hydraulic pump per competency of an operator in the crane according to the first embodiment of the present invention.

FIG. 5 is a graph illustrating a relationship of an amount of change in number of rotations of the hydraulic pump with respect to a unit operation amount of the accelerator pedal per competency of the operator in the crane according to the first embodiment of the present invention.

FIG. 6 is a graph illustrating a relationship of a movement speed of each hydraulic actuator with respect to a unit operation amount of an operation implement for crane apparatus per competency of the operator in the crane according to the first embodiment of the present invention.

FIG. 7 is a graph illustrating a relationship of an amount of change in movement speed of each hydraulic actuator with respect to a unit operation amount of the operation implement for crane apparatus per competency of the operator in the crane according to the first embodiment of the present invention.

FIG. 8 is a graph illustrating a relationship of a movement speed of each hydraulic actuator with respect to an operation amount per unit time of the operation implement for crane apparatus per competency of the operator in the crane according to the first embodiment of the present invention.

FIG. 9 is a control block diagram of a crane according to a second embodiment of the present invention.

FIG. 10 is a schematic view illustrating a step for performing machine learning for a competency-related information generation model that the crane according to the second embodiment of the present invention includes.

FIG. 11 is a control block diagram of a modification example of the crane according to the second embodiment of the present invention.

FIG. 12 is a control block diagram of a crane according to a third embodiment of the present invention and a server.

### DESCRIPTION OF EMBODIMENTS

Technical terms used in the present specification are used for the purpose of defining only certain examples, and the technical terms are not intended to limit the present invention.

As used in the present specification, the term “and/or” includes a single component and all combinations of a plurality of components listed in an associated manner.

Although, when “including,” “comprising,” or “having,” and their variations are used in the present specification, it is specified that stated features, steps, elements, components, and/or their equivalents exist, it is possible to include one or more of steps, operations, elements, components, and/or their groups.

In the present specification, the terms “attached,” “connected,” “coupled,” and/or their equivalents are used in a broad sense and encompass attachment, connection, and coupling both “directly and indirectly”. Furthermore, the terms “connected” and “coupled” are not limited to physical or mechanical connections or couplings, but may include direct or indirect connections or couplings.

In the present specification, embodiments of a crane according to the present invention will be described.

In the following description, many specific examples are described for providing a thorough understanding of the present invention. However, it will be apparent to those skilled in the art that the present invention is capable of being practiced without these specific examples.

Therefore, it should be considered that the disclosure described below is exemplified as mere examples of the present invention, and there is no intention of limiting the present invention to the certain embodiments illustrated with reference to the following drawings or description.

### Operation

In the present specification, movement of each actuator means a function and performance related to movement of each actuator such as a movement position, a number of rotations, a movement speed, a rotation speed, a degree of acceleration of movement, a degree of rotation angular acceleration, and an output of each actuator such as a hydraulic cylinder, a hydraulic motor, and an engine, for example.

### Limitation of Movement

In the present specification, limitation of movement means an action of changing a range of each of the movement position, the number of rotations, the movement speed, the rotation speed, the degree of acceleration of movement, the degree of rotation angular acceleration, and the output of each actuator, for example. The limitation of movement related to each actuator includes, for example, not only a case where an upper limit value related to movement of each actuator is changed downward or a lower limit value is changed upward, but also a case where a desirably set limit value related to movement of each actuator is changed to a desired value.

### Learning

In the present specification, learning or machine learning means work for adjusting parameters of a model (a program) to allow an output with respect to an input to be a correct answer in a machine (a processor). In the present embodiment, for supervised learning for performing learning based on teacher information in which input data and a correct answer with respect to the input data are combined with each other or unsupervised learning for determining whether or not there is a correct answer by utilizing only input data, at least supervised learning is performed for a competency-related information generation model that is a learning target.

### Model

In the present specification, a model means a specific calculation formula, a specific function, and a specific calculation method for which learning has been performed. A model is a mathematical expression representing a relationship of an output with respect to an input. The model converts inputted data in accordance with the mathematical expression. An action of creating a model means an action of performing learning on the model. As a model, there are a regression model for predicting a value and a classification model for classifying data, for example.

### Neural Network Model

In the present specification, a neural network model means a mathematical model in which a plurality of processing units for linearly converting an input are combined with each other. The neural network model includes an input layer, at least one intermediate layer, an output layer, a function for coupling the input layer and the intermediate layer with each other, and a function for coupling the intermediate layer and the output layer with each other. The input layer, the intermediate layer, and the output layer represent a plurality of variables to which data is to be inputted. The neural network model uses the functions to sequentially convert data inputted into the input layer and to output the converted data. The parameters of the functions in the neural network model are adjusted (undergo learning) to allow data outputted when teacher data including a combination of data and a correct answer with respect to the data is inputted into the input layer to approach the correct answer of the teacher data. By allowing the neural network model to repeatedly undergo learning, it is possible to reduce an error between data to be outputted based on data to be inputted and a correct answer.

### Viewpoint

In the present specification, a viewpoint means a position on which a line of sight is focused when a target is seen. The viewpoint of an operator includes not only a position on which the line of sight of the operator is consciously focused while the crane is operated, but also a position on which the line of sight is unconsciously focused.

### Operation-Related Information

In the present specification, operation-related information means information related to an operation of an operation implement allowing the operator to operate the crane having a telescopic boom that is able to be turned, raised, and lowered. The operation-related information includes, for example, information related to an operation amount per unit time, an operation timing, and an operation time of each operation implement in the crane.

### Posture-Related Information

In the present specification, posture-related information means information related to a posture of the crane. The posture-related information includes, for example, information related to a position of the crane, a turning angle of a turning table of the crane, a raising-and-lowering angle of the telescopic boom on the crane, a length of the telescopic boom on the crane, and a feeding amount of a wire rope on the crane.

### Suspended-Load-Related Information

In the present specification, suspended-load-related information means information related to a suspended load that the crane transports. The suspended-load-related information includes, for example, information related to a type of the suspended load, a weight of the suspended load, a load applied from the suspended load to the telescopic boom, a position per unit time of the suspended load with respect to the crane, a width of swinging with respect to the crane, a direction of swinging with respect to the crane, a cycle of swinging with respect to the crane, a first position at which the suspended load is to be hoisted from a ground contact surface, a second position at which the suspended load is to be lowered onto the ground contact surface, and a transport path for the suspended load.

### Viewpoint-Related Information

In the present specification, this is information related to the viewpoint of the operator when the operator operates the crane. The viewpoint-related information includes a position of the viewpoint of the operator per unit time when the operator sits on an operator's seat of the crane, a position of the viewpoint of the operator per unit time when the operator operates the crane, a direction of movement of the viewpoint of the operator, distribution of the viewpoints of the operator, and a number of blinks of the operator per unit time.

### Competency

In the present specification, competency means a degree of technique, skill, and ability of performing a certain task. Therefore, the competency of the operator of the crane means the degree of technique, skill, and ability when the operator operates the crane. The operator having high competency is excellent in technique, skill, and ability related to an operation of the crane. The competency for the crane includes, for example, a degree of technique, skill, and ability related to a magnitude of swinging of the suspended load, a transport speed of the suspended load, stability of the suspended load, accuracy of grounding of the suspended load, and safety.

### Hoisting-Competency-Related Information

In the present specification, hoisting-competency-related information means information related to competency of the operator when the operator hoists the suspended load from the first position by using the crane. The hoisting-competency-related information is expressed by, for example, a numerical value that allows competency of the operator hoisting the suspended load grounded at the first position upward to a predetermined height to be objectively compared based on a hoisting competency evaluation index.

### Hoisting Competency Evaluation Index

In the present specification, a hoisting competency evaluation index means an index for objectively evaluating competency of the operator when the operator hoists the suspended load from the ground contact surface by using the crane. For example, in the hoisting step for hoisting the suspended load from the first position, deflection of the telescopic boom of the crane increases due to an increase in load caused when the wire rope is wound. A position of a distal end of the telescopic boom moves outward in a direction of a working radius of the crane apparatus due to an increase in deflection. At this time, a frictional force between the suspended load and the ground contact surface is reduced as the wire rope is wound. The suspended load moves outward in the direction of the working radius when a force of pulling outward in the direction of the working radius, which is generated due to displacement in position of the suspended load with respect to the position of the distal end of the telescopic boom, becomes larger than the frictional force generated between the suspended load and the ground contact surface.

In the hoisting step, an operator having high competency (an expert) estimates an amount of movement of the position of the distal end of the telescopic boom based on an amount of winding of the wire rope and load information of the suspended load. Furthermore, the operator adjusts the position of the distal end of the telescopic boom with a raising-and-lowering operation of the telescopic boom to prevent the suspended load from moving in one of horizontal directions when hoisting. As described above, an index for evaluating a raising-and-lowering operation of the telescopic boom, a winding operation of the wire rope, a load change of the suspended load, information of the viewpoint of the operator, an operation time until completion of hoisting, and an operation timing of an operation implement, for example, by the operator in the hoisting step is used as the hoisting competency evaluation index. The hoisting competency evaluation index allows competency of the operator in the hoisting step to be converted into a numerical value, for example.

### Movement-Competency-Related Information

In the present specification, movement-competency-related information means information related to competency of the operator when the operator moves the suspended load in plan view by using the crane. The movement-competency-related information is expressed by, for example, a numerical value that allows competency of the operator moving the suspended load hoisted above the first position to the second position in plan view to be objectively compared based on a movement competency evaluation index.

### Movement Competency Evaluation Index

In the present specification, a movement competency evaluation index means an index for objectively evaluating competency of the operator when the operator moves the suspended load in one of the horizontal directions in plan view by using the crane. For example, in a transport step for moving the suspended load from the first position to the second position in plan view, the telescopic boom transports the suspended load through turning movement by using the turning table. The suspended load moves outward in a direction of a turning radius from the position of the distal end of the telescopic boom in plan view due to a centrifugal force generated along with the turning movement of the telescopic boom. In addition, the suspended load hoisted by the wire rope moves in a turning direction later than the movement of the distal end of the telescopic boom in the turning direction. Therefore, when the telescopic boom is stopped, the suspended load moves in the turning direction more than the distal end of the telescopic boom.

When the suspended load is positioned outside the distal end of the telescopic boom in the direction of the turning radius in the transport step, the operator having high competency lowers the telescopic boom to bring the position of the distal end of the telescopic boom closer to the suspended load in plan view. In addition, when the suspended load is positioned inside the distal end of the telescopic boom in the direction of the turning radius in the transport step, the operator raises the telescopic boom to bring the position of the distal end of the telescopic boom closer to the suspended load in plan view. Furthermore, in the transport step, the operator adjusts a turning speed of the telescopic boom to allow the suspended load to be positioned in front of the distal end of the telescopic boom in the turning direction during the turning movement, and to allow the distal end of the telescopic boom catches up with the suspended load at the second position. As described above, an index for evaluating operations of raising, lowering, and turning the telescopic boom, a position of the suspended load with respect to the position of the distal end of the telescopic boom, and a movement time, a movement speed, and an operation timing for an operation implement, until the suspended load moves from the first position to the second position, for example, by the operator in the transport step is used as the movement competency evaluation index. The movement competency evaluation index allows competency of the operator in the transport step to be converted into a numerical value, for example.

### Lowering-Competency-Related Information

In the present specification, lowering-competency-related information means information related to competency of the operator when the operator lowers the suspended load at the second position by using the crane. The lowering-competency-related information is expressed by, for example, a numerical value that allows competency of the operator lowering and allowing the suspended load positioned above the second position to be grounded at the second position to be objectively compared based on a lowering competency evaluation index.

### Lowering Competency Evaluation Index

In the present specification, a lowering competency evaluation index means an index for objectively evaluating competency of the operator when the operator lowers and allows the suspended load to be grounded by using the crane. For example, in a grounding step for lowering the suspended load at the second position, deflection of the telescopic boom decreases due to a decrease in load caused when the wire rope is unwound. The position of the distal end of the telescopic boom moves inward in the direction of the working radius of the crane apparatus due to a decrease in deflection. At this time, a frictional force between the suspended load and the ground contact surface is increased as the wire rope is unwound. The suspended load moves inward in the direction of the working radius until a force of pulling inward in the direction of the working radius, which is generated due to displacement in position of the suspended load with respect to the position of the distal end of the telescopic boom, becomes smaller than the frictional force generated between the suspended load and the ground contact surface.

In the grounding step, an operator having high competency estimates an amount of movement of the position of the distal end of the telescopic boom based on an amount of unwinding of the wire rope and load information of the suspended load. Furthermore, the operator adjusts the position of the distal end of the telescopic boom with a raising-and-lowering operation of the telescopic boom to prevent the suspended load from moving in one of the horizontal directions when grounding. As described above, an index for evaluating a raising-and-lowering operation of the telescopic boom, an unwinding operation of the wire rope, a load change of the suspended load, information of the viewpoint of the operator, an operation time until completion of grounding, and an operation timing of an operation implement, for example, by the operator in the grounding step is used as the lowering competency evaluation index. The lowering competency evaluation index allows competency of the operator in the grounding step to be converted into a numerical value, for example.

### Threshold Value

In the present specification, a threshold value means a level of competency for determining whether or not the operator is an expert having high competency. The threshold value represents, for example, a predetermined level in competency-related information evaluated based on the hoisting competency evaluation index, the movement competency evaluation index, and the lowering competency evaluation index for objectively evaluating competency of the operator. The threshold value is set based on a value calculated, for example, through statistical processing by using a mean value, a mean square, or a standard deviation, from the hoisting-competency-related information evaluated based on the hoisting competency evaluation index, the movement-competency-related information evaluated based on the movement competency evaluation index, and the lowering-competency-related information evaluated based on the lowering competency evaluation index. The operator having higher competency than the threshold value is determined to be an expert. The threshold value is set based on each of pieces of competency-related information accumulated through each of the steps or all the steps. In addition, for the threshold value, weighting may be set per step by assigning a coefficient to each of the pieces of competency-related information per step based on characteristics and tendencies, for example, of experts.

### First Embodiment

### Overall Configuration of Crane

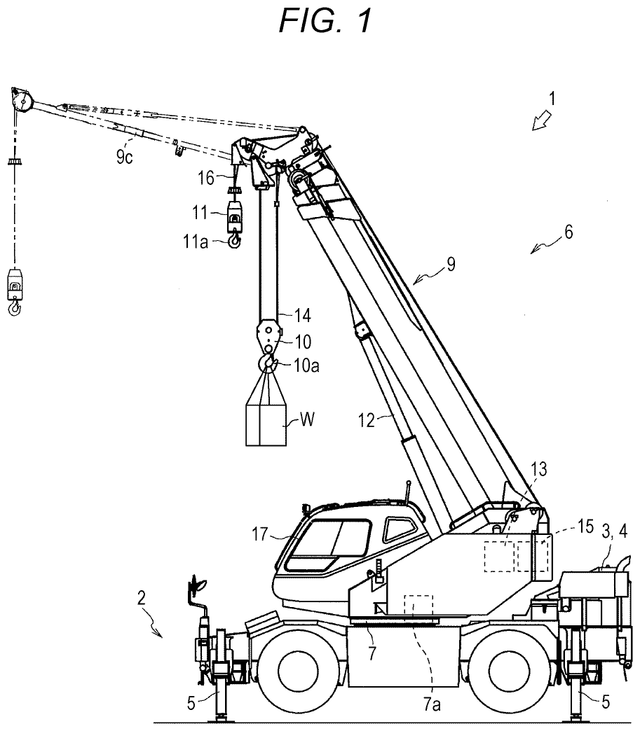

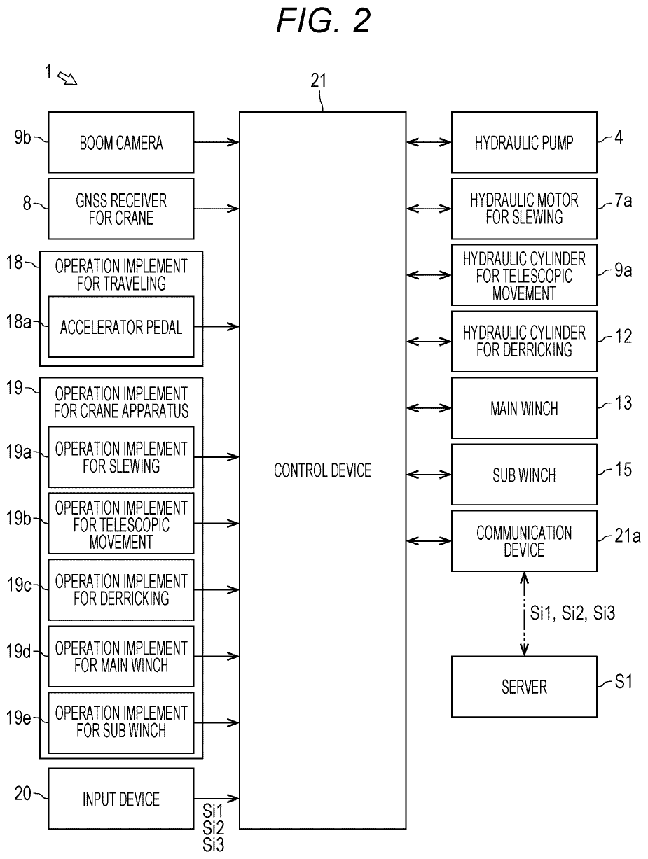

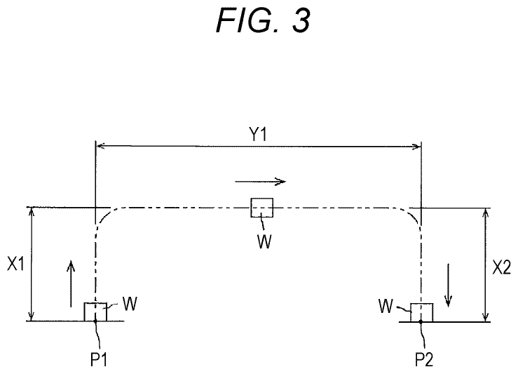

A crane 1 according to a first embodiment of the present invention will now be described herein with reference to FIGS. 1 to 8. FIG. 1 illustrates an overall configuration of the crane 1 according to the first embodiment of the present invention. FIG. 2 illustrates a control block diagram of the crane 1. FIG. 3 is a route diagram illustrating a hoisting step X1, a transport step Y1, and a grounding step X2 for which evaluation is to be performed by utilizing a competency-related information generation model 32 that the crane 1 and cranes 1A and 1B include.

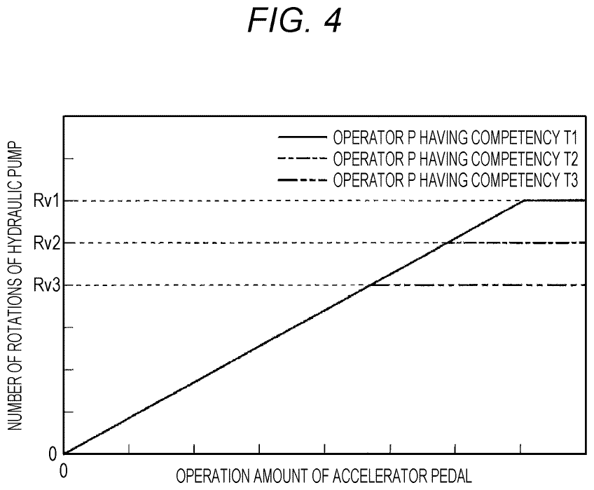

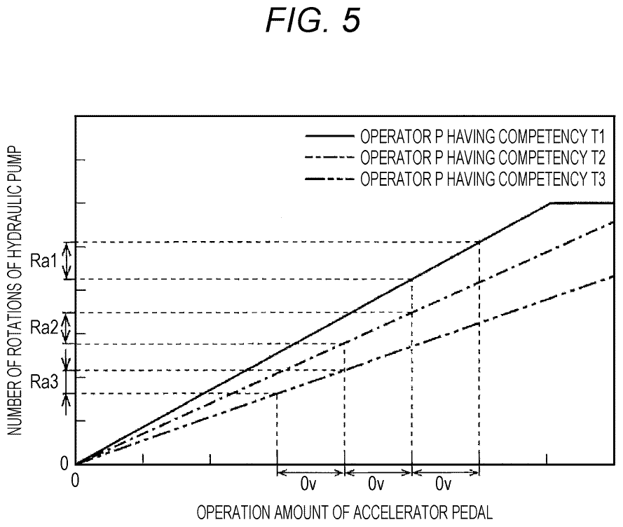

FIG. 4 is a graph illustrating a relationship between an operation amount of an accelerator pedal and a number of rotations of a hydraulic pump per competency of an operator P. FIG. 5 is a graph illustrating a relationship of an amount of change in number of rotations of a hydraulic pump 4 with respect to a unit operation amount of an accelerator pedal 18a per competency of the operator P.

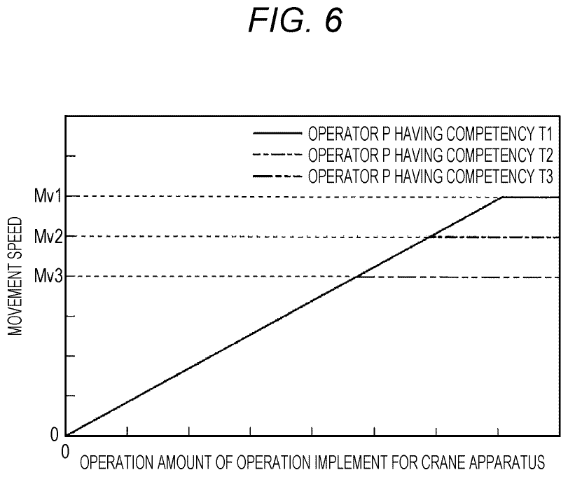

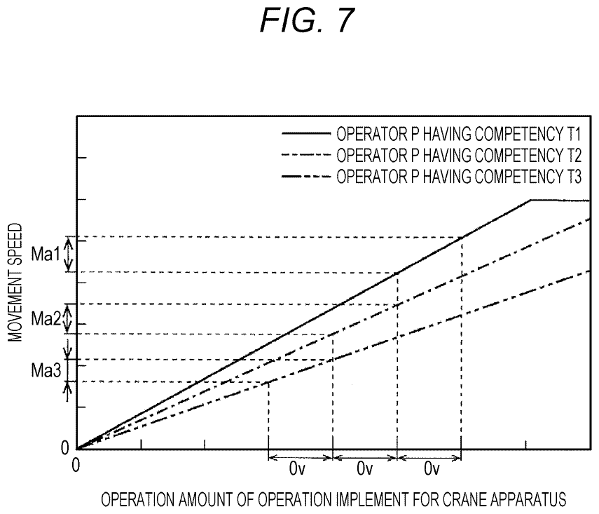

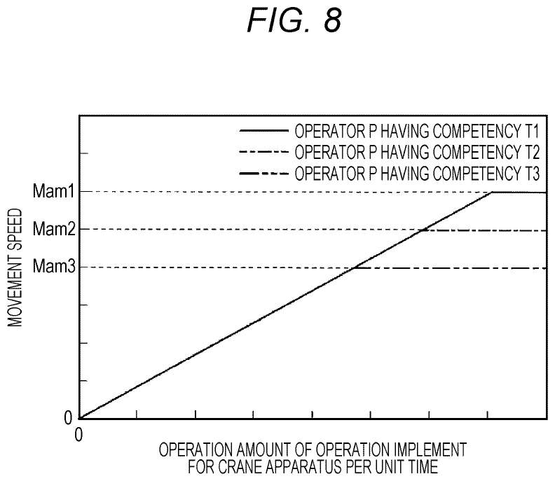

FIG. 6 is a graph illustrating a relationship of a movement speed of each hydraulic actuator with respect to a unit operation amount of an operation implement 19 for crane apparatus per competency of the operator P. FIG. 7 is a graph illustrating a relationship of an amount of change in movement speed of each hydraulic actuator with respect to a unit operation amount of the operation implement 19 for crane apparatus per competency of the operator P. FIG. 8 is a graph illustrating a relationship of a movement speed of each hydraulic actuator with respect to an operation amount per unit time of the operation implement 19 for crane apparatus per competency of the operator P.

In each of embodiments described below, a crane includes a telescopic boom that is able to be turned, raised, and lowered. In addition, as the crane, the crane 1 that is a rough terrain crane (hereinafter simply referred to as a “crane”) will be described. However, the crane may be an all terrain crane or a truck crane, for example. In addition, in the below description, the operator P refers to a person operating the crane.

As illustrated in FIG. 1, the crane 1 is a mobile crane that is capable of moving to a desired place. The crane 1 includes a vehicle 2, a crane apparatus 6, and a control device 21 (see FIG. 2).

The vehicle 2 is a travelling body that transports the crane apparatus 6. The vehicle 2 includes a plurality of wheels and is configured to be able to travel. The vehicle 2 uses an engine 3 as a power source to travel. In addition, the engine 3 drives the hydraulic pump 4 that supplies hydraulic oil to a hydraulic actuator of the crane 1. The vehicle 2 includes outriggers 5.

The crane apparatus 6 is a work apparatus that uses a wire rope to hoist a suspended load W. The crane apparatus 6 includes a turning table 7, a telescopic boom 9, a main hook block 10, a sub hook block 11, a hydraulic cylinder 12 for derricking, a main winch 13, a main wire rope 14, a sub winch 15, a sub wire rope 16, and a cabin 17, for example.

The turning table 7 is a rotation device that allows the crane apparatus 6 to turn. The turning table 7 is provided on a frame of the vehicle 2 via an annular bearing. The turning table 7 includes a hydraulic motor 7a for slewing, which is a hydraulic type and serves as an actuator. The turning table 7 is capable of turning in one direction and another direction with the hydraulic motor 7a for slewing.

A global navigation satellite system (GNSS) receiver 8 for crane (see FIG. 2) is a receiver constituting a global navigation satellite system. The GNSS receiver 8 for crane receives, from a satellite, a radio wave for measuring a distance, and detects a latitude, a longitude, an altitude, and an orientation, for example, which form absolute coordinates of the GNSS receiver 8 for crane. The GNSS receiver 8 for crane is provided on the turning table 7.

The telescopic boom 9 is a movable support supporting the main wire rope 14 and the sub wire rope 16. The telescopic boom 9 includes a plurality of boom members. A base end of a base boom member of the telescopic boom 9 is provided to be able to swing at a substantially center of the turning table 7.

The telescopic boom 9 includes a hydraulic cylinder 9a for telescopic movement (see FIG. 2), which is an actuator for causing each of the boom members to extend and contract, and a hydraulic cylinder 12 for derricking, which causes the boom members to be raised and lowered. The hydraulic cylinder 9a for telescopic movement causes the telescopic boom 9 to be extended and contracted in axial directions. In addition, the telescopic boom 9 includes a boom camera 9b that is an imaging device that captures an image of the suspended load W and a jib 9c that is an extension member. The boom camera 9b (see FIG. 2) is positioned at a distal end part of the telescopic boom 9.

The main hook block 10 and the sub hook block 11 are components for suspending the suspended load W. The main hook block 10 includes a plurality of hook sheaves, around which the main wire rope 14 is wound, and a main hook 10a for suspending the suspended load W. The sub hook block 11 includes a sub hook 11a for suspending the suspended load W.

The main winch 13 is a device that winds and unwinds the main wire rope 14. The sub winch 15 is a device that winds and unwinds the sub wire rope 16.

The cabin 17 is a housing that covers an operator's seat. The cabin 17 is mounted on the turning table 7. The non-illustrated operator's seat is provided in the cabin 17. The operator's seat is provided with an operation implement 18 for traveling for performing a travel operation of the vehicle 2 and an operation implement 19 for crane apparatus for the crane apparatus 6, for example (see FIG. 2). In addition, the cabin 17 is provided with an input device 20 for inputting competency-related information, for example, of the operator P.

As illustrated in FIG. 2, the operation implement 18 for traveling includes the accelerator pedal 18a that is an operation implement for operating the engine 3 and the hydraulic pump 4. The operation implement 19 for crane apparatus includes an operation implement 19a for slewing, which is an operation implement for operating the hydraulic motor 7a for slewing.

The operation implement 19 for crane apparatus includes an operation implement 19b for telescopic movement, which is an operation implement for operating the hydraulic cylinder 9a for telescopic movement. The operation implement 19 for crane apparatus includes an operation implement 19c for derricking, which is an operation implement for operating the hydraulic cylinder 12 for derricking. The operation implement 19 for crane apparatus includes an operation implement 19d for main winch, which is an operation implement for operating the main winch 13. The operation implement 19 for crane apparatus includes an operation implement 19e for sub winch, which is an operation implement for operating the sub winch 15.

The control device 21 controls each actuator of the crane 1. The control device 21 is provided in the cabin 17 (see FIG. 1). Practically, a central processing unit (CPU), a read-only memory (ROM), a random access memory (RAM), and a hard disk drive (HDD), for example, are coupled to the control device 21 through a bus.

Alternatively, the control device 21 includes a large-scale integrated circuit (LSI) in a form of a single chip, for example. The control device 21 stores various types of programs and various types of pieces of data for controlling movement of each actuator and each switching valve and for processing image data, for example.

The control device 21 includes a communication device 21a. The communication device 21a is electrically coupled to an external server S1. The control device 21 is able to transmit and receive various types of pieces of information to and from the server S1 via the communication device 21a. The control device 21 is able to acquire hoisting-competency-related information Si1, movement-competency-related information Si2, and lowering-competency-related information Si3 of the operator P of the crane 1 from the server S1 via the communication device 21a.

As illustrated in FIG. 3, the hoisting-competency-related information Si1 is information related to competency when the operator P hoists the suspended load W from a first position Pl by using the crane 1. The movement-competency-related information Si2 is information related to competency when the operator P moves the suspended load W positioned above the first position Pl to a position above a second position P2 by using the crane 1. The lowering-competency-related information Si3 is information related to competency when the operator P lowers the suspended load W positioned above the second position P2 at the second position P2 by using the crane 1.

In other words, the hoisting-competency-related information Si1 is information indicating competency of the operator related to work for hoisting the suspended load. In addition, the movement-competency-related information Si2 is information indicating competency of the operator related to work for horizontally transporting the suspended load. In addition, the lowering-competency-related information Si3 is information indicating competency of the operator related to work for lowering the suspended load.

As illustrated in FIG. 2, the hoisting-competency-related information Si1, the movement-competency-related information Si2, and the lowering-competency-related information Si3 are, for example, information acquired by evaluating competency of the operator P per step when competency of an expert is rated as 10 points and competency of a beginner is rated as one point. In addition, the control device 21 is able to comprehensively evaluate competency of the operator P based on the hoisting-competency-related information Si1, the movement-competency-related information Si2, and the lowering-competency-related information Si3, which are evaluation of the operator P per step.

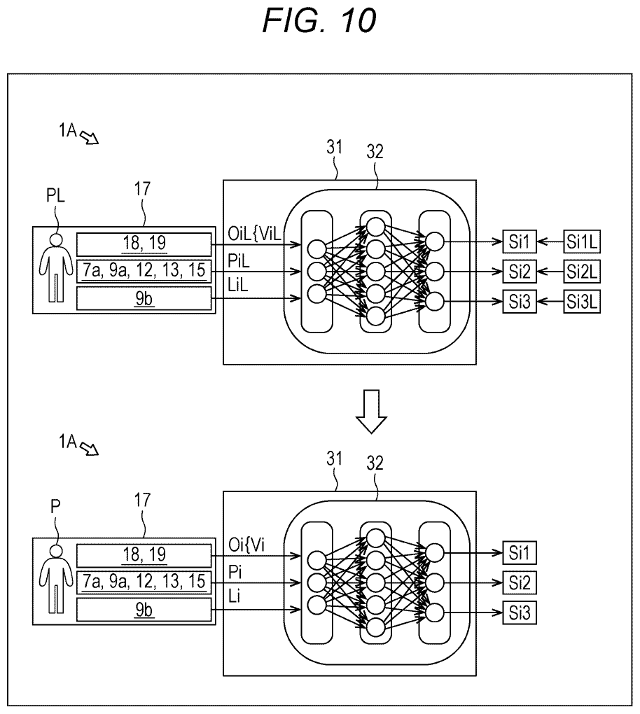

Note that, in the embodiments described below, an expert is, for example, an operator P (see FIG. 10) whose total operation time of the crane 1 exceeds a predetermined time and whose evaluation of the hoisting-competency-related information Si1, the movement-competency-related information Si2, and the lowering-competency-related information Si3 based on a self-report or evaluation by a third party is equal to or higher than a threshold value, when the threshold value is regarded to be equal to or higher than a mean value of a certain number of operators.

The control device 21 is coupled to the GNSS receiver 8 for crane. The control device 21 is able to acquire information related to a position of the crane 1. The control device 21 is coupled to the boom camera 9b. The control device 21 is able to continuously acquire a current image captured by the boom camera 9b per unit time.

The control device 21 is electrically coupled to the accelerator pedal 18a. An operation signal that is an operation amount per unit time of the accelerator pedal 18a is inputted into the control device 21. The control device 21 is electrically coupled to the operation implement 19a for slewing, the operation implement 19b for telescopic movement, the operation implement 19c for derricking, the operation implement 19d for main winch, and the operation implement 19e for sub winch.

Operation signals that are operation amounts per unit time of the operation implement 19a for slewing, the operation implement 19b for telescopic movement, the operation implement 19c for derricking, the operation implement 19d for main winch, and the operation implement 19e for sub winch are inputted into the control device 21. The control device 21 is able to generate control signals for the hydraulic pump 4 and the crane apparatus 6 based on operation signals inputted from the operation implement 18 for traveling and the operation implement 19 for crane apparatus. The control device 21 is able to transmit the generated control signals to each actuator.

The control device 21 is electrically coupled to the input device 20. It is possible to input the hoisting-competency-related information Si1, the movement-competency-related information Si2, and the lowering-competency-related information Si3 of the operator P of the crane 1 into the control device 21 from the input device 20.

The control device 21 is able to limit movement of the hydraulic pump 4, the hydraulic motor 7a for slewing, the hydraulic cylinder 9a for telescopic movement, the hydraulic cylinder 12 for derricking, the main winch 13, and the sub winch 15 based on the hoisting-competency-related information Si1, the movement-competency-related information Si2, and the lowering-competency-related information Si3 of the operator P, which are to be acquired from the server S1 or the input device 20.

The control device 21 is able to change, for example, a maximum number of rotations and an amount of change in number of rotations of the hydraulic pump 4 based on the hoisting-competency-related information Si1, the movement-competency-related information Si2, and the lowering-competency-related information Si3 of the operator P.

The crane 1 configured as described above is able to allow the vehicle 2 to move to a desired position as the operation implement 18 for traveling is operated. In addition, the crane 1 is able to transport the suspended load W to a desired position by causing the telescopic boom 9 to be turned, raised, lowered, extended, and contracted as the accelerator pedal 18a and the operation implement 19 for crane apparatus are operated.

In addition, the crane 1 is able to hoist and lower the suspended load W with the main winch 13 or the sub winch 15 as the operation implement 19 for crane apparatus is operated. In addition, the crane 1 is able to limit turning movement, raising-and-lowering movement, and extending-and-contracting movement of the telescopic boom 9 and winding-and-unwinding movement of the main winch 13 and the sub winch 15 based on the acquired hoisting-competency-related information Si1, the acquired movement-competency-related information Si2, and the acquired lowering-competency-related information Si3 of the operator P.

### Limitation of Movement of Actuator Based on Competency-Related Information

Next, limitation of movement of an actuator of the crane 1 will now be described with reference to FIGS. 2 to 8. As illustrated in FIG. 2, the control device 21 of the crane 1 acquires the hoisting-competency-related information Si1, the movement-competency-related information Si2, and the lowering-competency-related information Si3 of the operator P from the server S1 based on information related to the operator P, which is to be inputted via the communication device 21a or from the input device 20.

The control device 21 sets competency of the operator P based on the acquired hoisting-competency-related information Si1, the acquired movement-competency-related information Si2, and the acquired lowering-competency-related information Si3 of the operator P. In the present embodiment, the control device 21 displays evaluation of competency of the operator P in 10 grades from level 1 to level 10. The control device 21 limits movement of an actuator based on the set competency of the operator P.

### Limitation of Maximum Number of Rotations of Hydraulic Pump 4

When a maximum number of rotations of the hydraulic pump 4 is to be limited, the control device 21 changes, in accordance with competency of the operator P, a control signal to be transmitted to the hydraulic pump 4 based on an operation signal when the accelerator pedal 18a for operating the hydraulic pump 4 is operated to a maximum operation position. That is, the control device 21 limits, in accordance with competency of the operator P, a maximum movement speed of a hydraulic actuator that the crane 1 includes based on an amount of supply of the hydraulic oil.

As illustrated in FIG. 4, the control device 21 does not change a maximum number of rotations of the hydraulic pump 4 when, for example, competency of the operator P is competency T1, that is, at an advanced level (for example, ranging from level 10 to level 8) corresponding to that of an expert. That is, the control device 21 generates a control signal setting a number of rotations Rv1, which is a maximum number of rotations that the hydraulic pump 4 is able to output, as a maximum number of rotations of the hydraulic pump 4.

For example, when competency of the operator P is competency T2, that is, at a middle level (for example, ranging from level 7 to level 5), the control device 21 changes a maximum number of rotations of the hydraulic pump 4 to a number of rotations Rv2, which is lower than the number of rotations Rv1. For example, when competency of the operator P is competency T3, that is, at a basic level or a beginner level (for example, ranging from level 4 to level 1), the control device 21 changes a maximum number of rotations of the hydraulic pump 4 to a number of rotations Rv3, which is lower than the number of rotations Rv2. That is, the control device 21 limits a maximum number of rotations of the hydraulic pump 4 in accordance with competency of the operator P.

The control device 21 generates a control signal allowing the hydraulic pump 4 to rotate at a number of rotations equal to or lower than the number of rotations Rv2 in accordance with competency of the operator P even when the accelerator pedal 18a is operated to the maximum operation position by the operator P having lower competency than the advanced level. Therefore, the operator P is able to operate a hydraulic actuator within a speed region where an operation is possible within a range of own competency.

### Limitation of Amount of Change in Number of Rotations of Hydraulic Pump 4

As illustrated in FIG. 5, when an amount of change in number of rotations of the hydraulic pump 4 per unit operation amount Ov of the accelerator pedal 18a (see FIG. 2) is to be limited, the control device 21 changes, in accordance with competency of the operator P, a control signal to be transmitted to the hydraulic pump 4 based on an operation signal when the accelerator pedal 18a for operating the hydraulic pump 4 (see FIG. 2) is operated by the unit operation amount Ov (for example, a depression angle of 1°). That is, the control device 21 (see FIG. 2) limits, in accordance with competency of the operator P, sensitivity of response of a hydraulic actuator that the crane 1 includes by an amount of supply of the hydraulic oil.

As illustrated in FIG. 5, the control device 21 does not change an amount of change in number of rotations of the hydraulic pump 4 per unit operation amount Ov of the accelerator pedal 18a, when, for example, competency of the operator P is competency T1, that is, at the advanced level (for example, ranging from level 10 to level 8). That is, the control device 21 generates a control signal setting an amount of change in number of rotations Ra1, which is a maximum amount of change in number of rotations that the hydraulic pump 4 is able to output, as an amount of change in number of rotations of the hydraulic pump 4 per unit operation amount Ov of the accelerator pedal 18a.

For example, the control device 21 changes an amount of change in number of rotations of the hydraulic pump 4 per unit operation amount Ov of the accelerator pedal 18a to an amount of change in number of rotations Ra2 that is smaller than the amount of change in number of rotations Ra1, when competency of the operator P is competency T2, that is, at the middle level (for example, ranging from level 7 to level 5).

For example, the control device 21 changes an amount of change in number of rotations of the hydraulic pump 4 per unit operation amount Ov of the accelerator pedal 18a to an amount of change in number of rotations Ra3 that is smaller than the amount of change in number of rotations Ra2, when competency of the operator P is competency T3, that is, at the basic level or the beginner level (for example, ranging from level 4 to level 1). That is, the control device 21 limits an amount of change in number of rotations of the hydraulic pump 4 per unit operation amount Ov of the accelerator pedal 18a in accordance with competency of the operator P.

The control device 21 generates a control signal allowing the hydraulic pump 4 to rotate at an amount of change in number of rotations equal to or lower than the amount of change in number of rotations Ra2 in accordance with competency of the operator P even when the accelerator pedal 18a is operated by the operator P having lower competency than the advanced level. Therefore, the operator P is able to operate a hydraulic actuator with sensitivity of response with which an operation is possible within a range of own competency.

In addition, the control device 21 is able to change, in accordance with competency of the operator P, both a maximum number of rotations of the hydraulic pump 4 and an amount of change in number of rotations of the hydraulic pump 4 per unit operation amount Ov of the accelerator pedal 18a. The control device 21 generates a control signal allowing the hydraulic pump 4 to rotate at an amount of change in number of rotations equal to or lower than the amount of change in number of rotations Ra2 in accordance with competency of the operator P when the accelerator pedal 18a is operated by the operator P having lower competency than the advanced level.

In addition, the control device 21 generates a control signal allowing the hydraulic pump 4 to rotate at a maximum number of rotations equal to or lower than the maximum number of rotations Rv2 in accordance with competency of the operator P when the accelerator pedal 18a is operated to the maximum operation position.

### Limitation of Maximum Movement Speed of Hydraulic Actuator

As illustrated in FIG. 2, when a maximum movement speed of each of the hydraulic motor 7a for slewing, the hydraulic cylinder 9a for telescopic movement, the hydraulic cylinder 12 for derricking, the main winch 13, and the sub winch 15 is to be limited, the control device 21 changes, in accordance with competency of the operator P, a control signal to be transmitted to each of the hydraulic motor 7a for slewing, the hydraulic cylinder 9a for telescopic movement, the hydraulic cylinder 12 for derricking, the main winch 13, and the sub winch 15 (hereinafter simply referred to as “each hydraulic actuator”) based on an operation signal when each of the operation implement 19a for slewing, the operation implement 19b for telescopic movement, the operation implement 19c for derricking, the operation implement 19d for main winch, and the operation implement 19e for sub winch (hereinafter simply referred to as the “operation implement 19 for crane apparatus”) is operated to the maximum operation position. That is, the control device 21 limits, in accordance with competency of the operator P, a maximum movement speed of each hydraulic actuator that the crane 1 includes based on a degree of opening of a proportional control valve that each hydraulic actuator includes, for example.

As illustrated in FIG. 6, the control device 21 does not change a maximum movement speed of each hydraulic actuator when, for example, competency of the operator P is competency T1, that is, at the advanced level (for example, ranging from level 10 to level 8). That is, the control device 21 generates a control signal setting a movement speed Mv1 that is a maximum movement speed that each hydraulic actuator is able to output as a maximum movement speed of each hydraulic actuator.

The control device 21 changes a maximum movement speed of each hydraulic actuator to a movement speed Mv2 that is lower than the movement speed Mv1, when, for example, competency of the operator P is competency T2, that is, at the middle level (for example, ranging from level 7 to level 5).

The control device 21 changes a maximum movement speed of each hydraulic actuator to a movement speed Mv3 that is lower than the movement speed Mv2, when, for example, competency of the operator P is competency T3, that is, at the basic level or the beginner level (for example, ranging from level 4 to level 1). That is, the control device 21 limits, in accordance with competency of the operator P, a maximum movement speed of each hydraulic actuator.

The control device 21 generates a control signal allowing each hydraulic actuator to move at a movement speed equal to or lower than the movement speed Mv2 in accordance with competency of the operator P even when the operation implement 19 for crane apparatus is operated to the maximum operation position by the operator P having lower competency than the advanced level. Therefore, the operator P is able to operate each hydraulic actuator within a speed region where an operation is possible within a range of own competency.

Note that the control device 21 is able to individually change a maximum movement speed of each hydraulic actuator. That is, the control device 21 is able to change a maximum movement speed of at least one of the hydraulic actuators to a movement speed in accordance with competency of the operator P.

### Limitation of Amount of Change in Movement Speed With Respect to Operation of Operation Implement for Hydraulic Actuator

As illustrated in FIG. 7, when an amount of change in movement speed of each hydraulic actuator per unit operation amount Ov of the operation implement 19 for crane apparatus (see FIG. 2) is to be limited, the control device 21 (see FIG. 2) changes, in accordance with competency of the operator P, a control signal to be transmitted to each hydraulic actuator based on an operation signal when the operation implement 19 for crane apparatus is operated by the unit operation amount Ov (for example, an operation angle of 1°). That is, the control device 21 limits, in accordance with competency of the operator P, sensitivity of response of each hydraulic actuator that the crane 1 includes based on a degree of opening of the proportional control valve that the hydraulic actuator includes, for example.

The control device 21 does not change an amount of change in movement speed of each hydraulic actuator per unit operation amount Ov of the operation implement 19 for crane apparatus, when, for example, competency of the operator P is competency T1, that is, at the advanced level (for example, ranging from level 10 to level 8).

That is, the control device 21 generates a control signal setting an amount of change in movement speed Ma1 that is a maximum amount of change in movement speed that each hydraulic actuator is able to output as an amount of change in movement speed of each hydraulic actuator per unit operation amount Ov of the operation implement 19 for crane apparatus.

The control device 21 changes an amount of change in movement speed of each hydraulic actuator per unit operation amount Ov of the operation implement 19 for crane apparatus to an amount of change in movement speed Ma2 that is smaller than the amount of change in movement speed Ma1, when, for example, competency the operator P is competency T2, that is, at the middle level (for example, ranging from level 7 to level 5).

The control device 21 changes an amount of change in movement speed of each hydraulic actuator per unit operation amount Ov of the operation implement 19 for crane apparatus to an amount of change in movement speed Ma3 that is smaller than the amount of change in movement speed Ma2, when, for example, competency of the operator P is competency T3, that is, at the basic level or the beginner level (for example, ranging from level 4 to level 1). That is, the control device 21 limits an amount of change in movement speed per unit operation amount Ov of each hydraulic actuator in accordance with competency of the operator P.

The control device 21 generates a control signal allowing each hydraulic actuator to move with an amount of change in movement speed equal to or lower than the amount of change in movement speed Ma2 in accordance with competency of the operator P even when the operation implement 19 for crane apparatus is operated by the operator P having lower competency than the advanced level. Therefore, the operator P is able to operate each hydraulic actuator with sensitivity of response with which an operation is possible within a range of own competency.

In addition, the control device 21 is able to change, in accordance with competency of the operator P, both a maximum movement speed of each hydraulic actuator and an amount of change in movement speed of each hydraulic actuator per unit operation amount Ov of the operation implement 19 for crane apparatus.

The control device 21 generates a control signal allowing each hydraulic actuator to move with an amount of change in movement speed equal to or lower than the amount of change in movement speed Ma2 in accordance with competency of the operator P when the operation implement 19 for crane apparatus is operated by the operator P having lower competency than the advanced level. In addition, the control device 21 generates a control signal allowing the hydraulic pump 4 to rotate at a maximum number of rotations equal to or lower than the maximum number of rotations Rv2 in accordance with competency of the operator P when the operation implement 19 for crane apparatus is operated to the maximum operation position.

### Limitation of Amount of Change in Movement Speed With Respect to Operation of Operation Implement for Hydraulic Actuator

As illustrated in FIG. 2, when a maximum amount of change in movement speed of each hydraulic actuator per unit time of the operation implement 19 for crane apparatus is to be limited, the control device 21 changes, in accordance with competency the operator P, a control signal to be transmitted to each hydraulic actuator based on an operation signal per unit time (for example, one second) of the operation implement 19 for crane apparatus.

That is, the control device 21 limits, in accordance with competency of the operator P, sensitivity of response of each hydraulic actuator that the crane 1 includes based on a degree of opening of the proportional control valve that the hydraulic actuator includes, for example.

As illustrated in FIG. 8, the control device 21 does not change a maximum amount of change in movement speed of each hydraulic actuator per unit time of the operation implement 19 for crane apparatus, when, for example, competency of the operator P is competency T1, that is, at the advanced level (for example, ranging from level 10 to level 8). That is, the control device 21 generates a control signal setting an amount of change in movement speed Mam1 that is a maximum amount of change in movement speed that each hydraulic actuator is able to output as an amount of change in movement speed of each hydraulic actuator per unit time of the operation implement 19 for crane apparatus.

The control device 21 changes a maximum amount of change in movement speed of each hydraulic actuator per unit time of the operation implement 19 for crane apparatus to an amount of change in movement speed Mam2 that is smaller than the amount of change in movement speed Mam1, when, for example, competency of the operator P is competency T2, that is, at the middle level (for example, ranging from level 7 to level 5).

The control device 21 changes a maximum amount of change in movement speed of each hydraulic actuator per unit time of the operation implement 19 for crane apparatus to an amount of change in movement speed Mam3 that is smaller than the amount of change in movement speed Mam2, when, for example, competency of the operator P is competency T3, that is, at the basic level or the beginner level (for example, ranging from level 4 to level 1). That is, the control device 21 limits, in accordance with competency of the operator P, a maximum amount of change in movement speed of each hydraulic actuator.

The control device 21 generates a control signal allowing each hydraulic actuator to move with an amount of change in movement speed equal to or smaller than the amount of change in movement speed Mam2 per unit time in accordance with competency of the operator P even when the operation implement 19 for crane apparatus is operated by the operator P having lower competency than the advanced level.

Therefore, the operator P is able to operate each hydraulic actuator with sensitivity of response with which an operation is possible within a range of own competency.

When it is evaluated that competency of the operator P is equivalent to the advanced level that is able to be regarded as that of an expert, the control device 21 of the crane 1 described above generates a control signal for each hydraulic actuator without limiting movement of each hydraulic actuator.

That is, when the crane 1 is operated by the operator P having competency corresponding to the advanced level, the crane 1 is configured to be operable in accordance with operations of the accelerator pedal 18a and the operation implement 19 for crane apparatus without limiting movement of each hydraulic actuator.

On the other hand, when it is evaluated that competency of the operator P is at the basic level, the control device 21 generates a control signal limiting maximum speeds, maximum torque, and amounts of change with respect to the unit operation amounts Ov of the accelerator pedal 18a and the operation implement 19 for crane apparatus of the hydraulic pump 4 and each hydraulic actuator, for example.

That is, when the crane 1 is operated by the operator P having competency at the basic level, for example, the crane 1 is configured to be operable in a state in which the maximum speeds, the maximum torque, and a maximum amount of change per unit operation amount Ov of the hydraulic pump 4 and each hydraulic actuator, for example, are each limited to a value equal to or smaller than a set value for the basic level.

In the crane 1, in FIGS. 4 and 5, at least one of a maximum number of rotations of the hydraulic pump 4 and an amount of change in number of rotations of the hydraulic pump 4 per unit operation amount Ov of the accelerator pedal 18a for operating the hydraulic pump 4 is limited in accordance with competency of the operator P.

For example, the crane 1 is configured to prevent the hydraulic pump 4 from being operated at the maximum number of rotations Rv3 and the amount of change in number of rotations Ra3 or greater, which are limited even when the accelerator pedal 18a is greatly depressed by the operator P at the basic level.

In the crane 1, in FIGS. 6 and 7, at least one of a maximum movement speed of each hydraulic actuator and an amount of change in speed of each hydraulic actuator per unit operation amount Ov of the operation implement 19 for crane apparatus for operating each hydraulic actuator is limited in accordance with competency of the operator P.

For example, the crane 1 is configured to prevent each hydraulic actuator from being operated at a maximum number of rotations and an amount of change in number of rotations or greater, which are limited even when the operation implement 19 for crane apparatus is greatly operated by the operator P at the basic level.

In the crane 1, in FIG. 8, an amount of change in movement speed per unit time of each hydraulic actuator is limited in accordance with competency of the operator P. For example, the crane 1 is configured to allow a movable portion of each actuator to move with an amount of change in movement speed for the basic level or lower even when the operation implement 19 for crane apparatus is suddenly operated by the operator P at the basic level.

That is, the crane 1 is adjusted by the control device 21 to allow the hydraulic pump 4 and each hydraulic actuator to operate within a range allowing the operator P to perform, with own competency, an operation with margin. As a result, it is possible to operate the crane 1 within a range in which it is possible to reduce a psychological and physical burden on the operator P when the operator P operates the crane 1 based on appropriately evaluated competency of the operator P.

### Second Embodiment

### Overall Configuration of Crane Evaluating Competency of Operator P

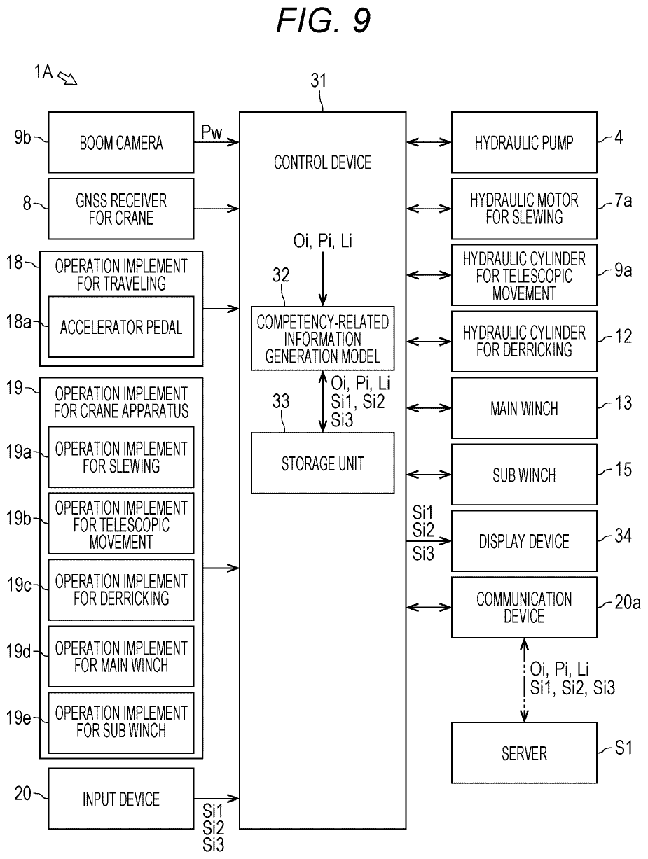

A crane 1A that makes it possible to evaluate competency of the operator P, according to a second embodiment of the present invention, will now be described herein with reference to FIGS. 3, 9, and 10. FIG. 9 is a control block diagram of the crane 1A according to the second embodiment of the present invention. FIG. 10 is a schematic view illustrating a step for performing machine learning for the competency-related information generation model 32 that the crane 1A includes. Note that, for similar or identical points to those in the embodiment described previously, their specific description will be omitted, and different points will be mainly described.

As illustrated in FIG. 9, the crane 1A is a mobile crane that is capable of moving to a desired place. The crane 1A includes a control device 31 and a display device 34.

The control device 31 controls each actuator of the crane 1. The control device 31 includes the competency-related information generation model 32 and a storage unit 33. The control device 31 stores various types of programs and various types of pieces of data for controlling the competency-related information generation model 32 and the storage unit 33.

The control device 31 is able to generate operation-related information Oi from operation signals of the operation implement 18 for traveling and the operation implement 19 for crane apparatus. In addition, the control device 31 is able to generate posture-related information Pi from information, for example, of sensors in the hydraulic motor 7a for slewing, the hydraulic cylinder 9a for telescopic movement, the hydraulic cylinder 12 for derricking, the main winch 13, and the sub winch 15. In addition, the control device 31 is able to generate suspended-load-related information Li from an image Pw of the suspended load, for example, which the boom camera 9b captures.

The competency-related information generation model 32 is utilized for evaluating competency of the operator P based on the operation-related information Oi, the posture-related information Pi, and the suspended-load-related information Li. The competency-related information generation model 32 is a model for machine learning, which undergoes learning based on teacher data created by an operator PL for learning (see FIG. 10).

The control device 31 is able to evaluate competency of the operator P operating the crane 1A. In the present embodiment, the control device 31 utilizes the competency-related information generation model 32 to generate at least either the hoisting-competency-related information Si1, the movement-competency-related information Si2, or the lowering-competency-related information Si3, which are information for evaluating competency of the operator P, based on the operation-related information Oi that is information related to an operation of the operation implement 19 for crane apparatus of the operator P for operating the crane 1, the posture-related information Pi that is information related to a posture of the crane 1, and the suspended-load-related information Li that is information related to the suspended load W transported by the crane 1.

Into the control device 31, it is possible to input the operation-related information Oi, the posture-related information Pi, and the suspended-load-related information Li of the operator P from the external server S1 via a communication device 20a. In addition, the control device 31 is able to output the operation-related information Oi, the posture-related information Pi, and the suspended-load-related information Li to the storage unit 33 and the display device 34.

The control device 31 is able to output the hoisting-competency-related information Si1, the movement-competency-related information Si2, and the lowering-competency-related information Si3, which have been created by utilizing the competency-related information generation model 32, to the storage unit 33 and the display device 34.

In addition, the control device 31 is able to output the operation-related information Oi, the posture-related information Pi, the suspended-load-related information Li, the hoisting-competency-related information Si1, the movement-competency-related information Si2, and the lowering-competency-related information Si3 to the external server S1, for example, via the communication device 20a.

The control device 31 is able to acquire various types of pieces of information including the operation-related information Oi, the posture-related information Pi, the suspended-load-related information Li, the hoisting-competency-related information Si1, the movement-competency-related information Si2, and the lowering-competency-related information Si3, which have been stored in the storage unit 33.

The storage unit 33 stores the operation-related information Oi, the posture-related information Pi, and the suspended-load-related information Li, which are to be inputted from the crane 1 or the server S1, for example. In addition, the storage unit 33 stores the hoisting-competency-related information Si1, the movement-competency-related information Si2, and the lowering-competency-related information Si3, for example, which are to be inputted from the control device 31.

The storage unit 33 includes a RAM, a memory inside a processor, and a hard disk, for example, which store the operation-related information Oi, the posture-related information Pi, the suspended-load-related information Li, the hoisting-competency-related information Si1, the movement-competency-related information Si2, and the lowering-competency-related information Si3, for example.

The storage unit 33 is able to output, to the control device 31, the operation-related information Oi, the posture-related information Pi, the suspended-load-related information Li, the hoisting-competency-related information Si1, the movement-competency-related information Si2, and the lowering-competency-related information Si3, for example, which have been stored.

The display device 34 displays at least one of the hoisting-competency-related information Si1, the movement-competency-related information Si2, and the lowering-competency-related information Si3, which have been created by the control device 31 by utilizing the competency-related information generation model 32. The display device 34 includes, for example, a liquid crystal display.

At least one of the hoisting-competency-related information Si1, the movement-competency-related information Si2, and the lowering-competency-related information Si3 is to be inputted to the display device 34 from the control device 31 or the storage unit 33. The display device 34 is able to transmit the competency-related information of the operator P to the operator P or a third party.

The control device 31 configured as described above creates at least one of the hoisting-competency-related information Si1, the movement-competency-related information Si2, and the lowering-competency-related information Si3 of the operator P based on the operation-related information Oi, the posture-related information Pi, and the suspended-load-related information Li by utilizing the competency-related information generation model 32.

The crane 1A is able to evaluate competency of the operator P per step requiring a different technique in operating the crane 1A.

### Creation of Competency-Related Information Generation Model 32

Next, creation of the competency-related information generation model 32 will now be described. The competency-related information generation model 32 is a model for machine learning, which is utilized for evaluating competency of the operator P based on the operation-related information Oi, the posture-related information Pi, and the suspended-load-related information Li. The competency-related information generation model 32 includes, for example, a neural network.

As illustrated in FIG. 10, the competency-related information generation model 32 is a model having undergone learning based on teacher information including a combination of operation-related information OiL for learning, posture-related information PiL for learning, and suspended-load-related information LiL for learning of the operator PL for learning, who has competency at the advanced level, and who corresponds to an expert having higher competency than the threshold value, and at least one of hoisting-competency-related information Si1L for learning, movement-competency-related information Si2L for learning, and lowering-competency-related information Si3L for learning based on a self-report by the operator PL for learning or evaluation by a third party.

The hoisting-competency-related information Si1L for learning is a label of a correct answer for competency evaluated based on a hoisting competency evaluation index that is an index for objectively evaluating competency of the operator PL when the operator PL hoists the suspended load W from the ground contact surface by using the crane 1.

The movement-competency-related information Si2L for learning is a label of a correct answer for competency evaluated based on a movement competency evaluation index that is an index for objectively evaluating competency of the operator PL when the operator PL moves the suspended load W in one of the horizontal directions in plan view by using the crane 1.

The lowering-competency-related information Si3L for learning is a label of a correct answer for competency evaluated based on a lowering competency evaluation index that is an index for objectively evaluating competency of the operator PL when the operator PL lowers the suspended load W on the ground contact surface for grounding by using the crane 1.

As illustrated in FIG. 10, the operation-related information OiL for learning, the posture-related information PiL for learning, and the suspended-load-related information LiL for learning, which have been acquired when the operator PL for learning uses the crane 1 to transport the suspended load W from at least the first position P1 to the second position P2 (see FIG. 3), are inputted as one piece of continuous information to the competency-related information generation model 32.

For example, the control device 31 divides the operation-related information OiL for learning, the posture-related information PiL for learning, and the suspended-load-related information LiL for learning, which have been generated through operations of the operator PL for learning, into a range of hoisting the suspended load W from the first position P1, a range of moving the suspended load W from the first position P1 to the second position P2, and a range of allowing the suspended load W to be grounded at the second position P2, per step.

Furthermore, the control device 31 utilizes the competency-related information generation model 32 to generate at least one of the hoisting-competency-related information Si1, the movement-competency-related information Si2, and the lowering-competency-related information Si3 based on the operation-related information OiL for learning, the posture-related information PiL for learning, and the suspended-load-related information LiL for learning, in each of the divided ranges.

As described above, the control device 31 is able to process the operation-related information OiL for learning, the posture-related information PiL for learning, and the suspended-load-related information LiL for learning as pieces of information related to each other by utilizing the competency-related information generation model 32.

As illustrated in FIGS. 3 and 10, in the hoisting step X1 for hoisting the suspended load W from the first position P1 by the crane 1A, the operator PL for learning often operates the operation implement 19c for derricking (see FIG. 9) to correct deflection of the telescopic boom 9 (see FIG. 1) immediately before the suspended load W is separated from the ground contact surface where an operation time for an operation implement for winding until immediately before the suspended load W is separated from the ground contact surface is short.

Therefore, during a period of time from when winding of the main wire rope 14 (see FIG. 1) is started to when the winding is ended, the control device 31 is able to perform evaluation as the hoisting-competency-related information Si1 of the operator PL for learning along the hoisting competency evaluation index based on the operation-related information Oi including information such as a required period of time, operation amounts, operation timings, and operation amounts per unit time of the operation implement for winding and the operation implement 19c for derricking with respect to a change in load applied to the telescopic boom 9 (see FIG. 1), the posture-related information Pi, and the suspended-load-related information Li by utilizing the competency-related information generation model 32.

In the transport step Y1 for moving the suspended load W from the first position P1 to the second position P2 by the crane 1A, the operator PL for learning adjusts the position of the distal end of the telescopic boom 9 and a position of the suspended load W in a turning direction through an operation of the operation implement 19a for slewing to allow the suspended load W to first reach the second position P2.

Furthermore, the operator PL for learning adjusts the position of the distal end of the telescopic boom 9 and the position of the suspended load W in a direction of a turning radius through an operation of the operation implement 19c for derricking to prevent the suspended load W from being separated from a center of turning due to a centrifugal force during turning.

Therefore, in transporting from the first position P1 to the second position P2, the control device 31 is able to utilize the competency-related information generation model 32 to perform evaluation as the movement-competency-related information Si2 of the operator PL for learning along the movement competency evaluation index based on the operation-related information Oi including information such as a required period of time, operation amounts, operation timings, and operation amounts per unit time of the operation implement 19a for slewing and the operation implement 19c for derricking, the posture-related information Pi, and the suspended-load-related information Li.

In the grounding step X2 for lowering the suspended load W at the second position P2, the operator PL for learning operates the operation implement 19c for derricking to correct deflection of the telescopic boom 9 immediately before the suspended load W comes into contact with the ground contact surface where an operation time for an operation implement for winding (unwinding) immediately before the suspended load W comes into contact with the ground contact surface is short.

Therefore, during a period of time from when unwinding of the main wire rope 14 is started to when the unwinding is ended, the control device 31 is able to perform evaluation as the lowering-competency-related information Si3 of the operator PL for learning along the lowering competency evaluation index based on the operation-related information Oi including information such as a required period of time, operation amounts, operation timings, and operation amounts per unit time of the operation implement 19d for main winch and the operation implement 19c for derricking with respect to a change in load applied to the telescopic boom 9, the posture-related information Pi, and the suspended-load-related information Li by utilizing the competency-related information generation model 32.

The control device 31 adjusts parameters for the competency-related information generation model 32 through machine learning to minimize as much as possible each of errors among the hoisting-competency-related information Si1, the movement-competency-related information Si2, and the lowering-competency-related information Si3, which have been generated by utilizing the competency-related information generation model 32, and the hoisting-competency-related information Si1L for learning, the movement-competency-related information Si2L for learning, and the lowering-competency-related information Si3L for learning, which are labels of correct answers of the teacher information.

The control device 31 repeats the machine learning until the errors each converge within a certain range. The control device 31 includes the competency-related information generation model 32 for which machine learning has been completed.

In the present embodiment, the competency-related information generation model 32 having undergone machine learning is utilized to generate at least one of the hoisting-competency-related information Si1, the movement-competency-related information Si2, and the lowering-competency-related information Si3 based on the operation-related information Oi, the posture-related information Pi, and the suspended-load-related information Li of the operator P.

The control device 31 is able to generate the hoisting-competency-related information Si1, the movement-competency-related information Si2, and the lowering-competency-related information Si3 by utilizing the competency-related information generation model 32 having undergone machine learning. The hoisting-competency-related information Si1, the movement-competency-related information Si2, and the lowering-competency-related information Si3 are pieces of competency-related information related to an operation of the crane 1A and a track of the suspended load W, including swinging of the suspended load W with respect to a posture of the crane 1A.

### Evaluation of Competency by Crane 1A

As illustrated in FIG. 9, when competency is to be evaluated, the control device 31 generates, as one piece of continuous information, each of the operation-related information Oi, the posture-related information Pi, and the suspended-load-related information Li of the operator P during a period of time from start of a step for hoisting the suspended load W from the first position P1 by the crane 1A to completion of the grounding step X2 for allowing the suspended load W to be grounded at the second position P2.

The control device 31 causes the storage unit 33 to store the generated operation-related information Oi, the generated posture-related information Pi, and the generated suspended-load-related information Li of the operator P.

Next, by utilizing the competency-related information generation model 32, the control device 31 generates at least one of the hoisting-competency-related information Si1, the movement-competency-related information Si2, and the lowering-competency-related information Si3 based on the operation-related information Oi, the posture-related information Pi, and the suspended-load-related information Li, which are pieces of information related to each other.

In addition, the control device 31 may evaluate overall competency acquired by comprehensively evaluating the hoisting-competency-related information Si1, the movement-competency-related information Si2, and the lowering-competency-related information Si3.

Next, the control device 31 outputs one piece of generated competency-related information among the hoisting-competency-related information Si1, the movement-competency-related information Si2, and the lowering-competency-related information Si3 to the storage unit 33 and the display device 34.

The storage unit 33 stores the one piece of generated competency-related information as certain competency-related information of the operator P in combination with the hoisting-competency-related information Si1, the movement-competency-related information Si2, and the lowering-competency-related information Si3.

The crane 1A configured as described above generates competency-related information for individually evaluating each of various types of competency required for the operator P in handling of the suspended load W. The competency-related information is information acquired by quantifying competency of the operator P into a numerical value per step in work for transporting the suspended load W by the crane 1A.

Therefore, the crane 1A outputs each of the hoisting-competency-related information Si1, the movement-competency-related information Si2, and the lowering-competency-related information Si3 of the operator P in all steps from the hoisting step for the suspended load W from the first position P1 to the grounding step X2 for the suspended load W at the second position P2.

In addition, the control device 31 generates the hoisting-competency-related information Si1, the movement-competency-related information Si2, and the lowering-competency-related information Si3 of the operator P by setting the operation-related information Oi, the posture-related information Pi, and the suspended-load-related information Li during a period of time from hoisting of the suspended load W from the first position P1 to grounding at the second position P2 by the crane 1A as one piece of continuous information.

That is, since the control device 31 individually evaluates competency in each step in a series of operations until the operator P transports the suspended load W from the first position P1 to the second position P2 by using the crane 1A, it is possible to eliminate information unnecessary for evaluating competency.

Furthermore, the control device 31 is able to evaluate competency of the operator P as a degree of proficiency by using that of an expert as a reference by utilizing the competency-related information generation model 32 having undergone machine learning by using information including the operation-related information Oi, the posture-related information Pi, and the suspended-load-related information Li of the expert as, for machine learning, the operation-related information OiL for learning, the posture-related information PiL for learning, and the suspended-load-related information LiL for learning.

As a result, it is possible to evaluate in more detail the hoisting-competency-related information Si1, the movement-competency-related information Si2, and the lowering-competency-related information Si3 of the operator P in each step of the hoisting step X1 for the suspended load W from the first position P1, the transport step Y1 for the suspended load W from the first position P1 to the second position P2, and the grounding step X2 for the suspended load W at the second position P2, which require different competency in handling of the suspended load W.

The control device 31 sets competency of the operator P based on the generated hoisting-competency-related information Si1, the generated movement-competency-related information Si2, and the generated lowering-competency-related information Si3 of the operator P. For example, the control device 31 changes, in accordance with the set competency of the operator P, a control signal to be transmitted to the hydraulic pump 4 based on an operation signal when the operation implement 19 for crane apparatus for operating each hydraulic actuator is operated to the maximum operation position.

That is, the control device 31 limits, in accordance with competency of the operator P, a maximum movement speed of each hydraulic actuator that the crane 1A includes based on an amount of supply of the hydraulic oil. As described above, it is possible to perform an operation within a range in which it is possible to reduce a psychological and physical burden on the operator P when the operator P operates the crane 1A based on appropriately evaluated competency of the operator P.

### Modification Example of Crane 1A

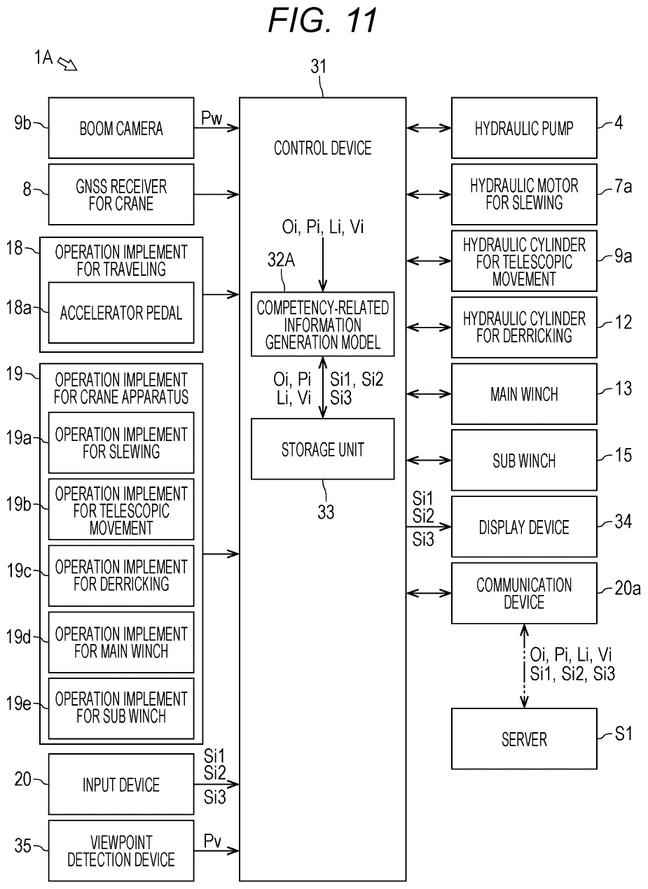

Next, a modification example of the crane 1A will now be described with reference to FIG. 11. FIG. 11 is a control block diagram of the modification example of the crane 1A according to the second embodiment. The control device 31 in the modification example of the crane 1A may output at least one of the hoisting-competency-related information Si1, the movement-competency-related information Si2, and the lowering-competency-related information Si3, which are information for evaluating competency of the operator P, based on the operation-related information Oi including viewpoint-related information Vi that is information related to the viewpoint of the operator P when the operator P operates the crane 1A, the posture-related information Pi, and the suspended-load-related information Li.

As illustrated in FIG. 11, the crane 1A includes a viewpoint detection device 35 that detects the viewpoint of the operator P when the operator P operates the crane 1A. The viewpoint detection device 35 is, for example, an eyeglass type wearable terminal. The viewpoint detection device 35 generates a viewpoint detection image Pv acquired by synthesizing an image of a field of view of a camera that captures a field of view of the operator P and an image of a viewpoint of a camera that detects a viewpoint on which the operator P is focusing. The viewpoint detection device 35 is able to output the generated viewpoint detection image Pv to the control device 31 of the crane 1A.

The control device 31 is electrically coupled to the viewpoint detection device 35. It is possible to input the viewpoint detection image Pv from the viewpoint detection device 35 into the control device 31. The control device 31 is able to generate the viewpoint-related information Vi from the inputted viewpoint detection image Pv.

The viewpoint-related information Vi is information in which competency of the operator P related to transportation of the suspended load W and a psychological state of the operator P are associated with each other from a position of the viewpoint of the operator P, a period of time during which the viewpoint stays per unit number of times, distribution of the viewpoints of the operator P, and a direction of movement of the viewpoint of the operator P, for example.

The control device 31 includes a competency-related information generation model 32A utilized for evaluating competency of the operator P based on the operation-related information Oi, the viewpoint-related information Vi, the posture-related information Pi, and the suspended-load-related information Li. The competency-related information generation model 32A is a model for machine learning, which is utilized for evaluating competency of the operator P based on the operation-related information Oi, the viewpoint-related information Vi, the posture-related information Pi, and the suspended-load-related information Li. The competency-related information generation model 32A includes, for example, a neural network.

The competency-related information generation model 32A having undergone machine learning is utilized to generate at least one of the hoisting-competency-related information Si1, the movement-competency-related information Si2, and the lowering-competency-related information Si3 based on the operation-related information Oi, the viewpoint-related information Vi, the posture-related information Pi, and the suspended-load-related information Li of the operator P.

The storage unit 33 stores the viewpoint-related information Vi inputted from the viewpoint detection device 35. The storage unit 33 is able to output the stored viewpoint-related information Vi to the control device 31.

As a result, the crane 1A is able to evaluate competency of the operator P in more detail by associating with each other a situation around the suspended load W of the operator P, movement of the suspended load W, a state of the crane 1A, and a psychological state of the operator P in each step of the hoisting step X1 for the suspended load W from the first position P1, the transport step Y1 for the suspended load W from the first position P1 to the second position P2, and the grounding step X2 for the suspended load W at the second position P2 (see FIG. 3) based on the operation-related information Oi, the viewpoint-related information Vi, the posture-related information Pi, and the suspended-load-related information Li.

It is known that thought, emotion, and a psychological state of the operator P indirectly appear in information related to the viewpoint of the operator P. That is, the control device 31 appropriately evaluates competency of the operator P by taking into consideration the thought, the emotion, and the psychological state of the operator P.

As described above, it is possible to perform an operation within a range in which it is possible to reduce a psychological and physical burden on the operator P when the operator P operates the crane 1A based on appropriately evaluated competency of the operator P.

### Third Embodiment

Configuration in Which Server includes Competency-Related Information Generation Model

### Overall Configuration of Crane 1B

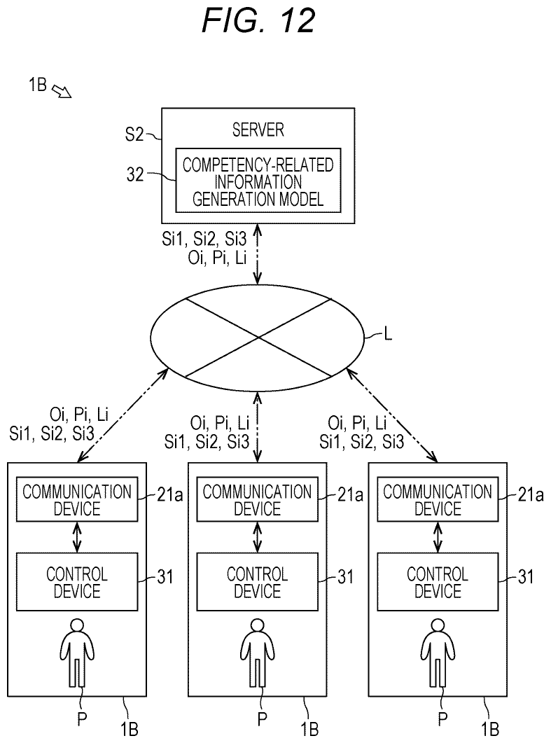

A crane 1B according to a third embodiment of the present invention will now be described herein with reference to FIG. 12. FIG. 12 is a control block diagram of the crane 1B according to the third embodiment of the present invention and a server S2.

As illustrated in FIG. 12, the crane 1B includes the competency-related information generation model 32. In addition, the crane 1B is electrically coupled to the external server S2 via a communication line L such as the Internet including at least one of a wired manner and a wireless manner via the communication devices 21a.

The competency-related information generation model 32 is positioned in the server S2. That is, the crane 1B is electrically coupled to the competency-related information generation model 32 in the server S2 via the communication device 21a.

The crane 1B generates at least one of the hoisting-competency-related information Si1, the movement-competency-related information Si2, and the lowering-competency-related information Si3, which are information for evaluating competency of the operator P, based on the operation-related information Oi, the posture-related information Pi, and the suspended-load-related information Li by utilizing the competency-related information generation model 32 in the server S2.

The control device 31 of each crane 1B acquires a generated piece of competency-related information among the hoisting-competency-related information Si1, the movement-competency-related information Si2, and the lowering-competency-related information Si3 from the server S2 via the communication line L.

The control device 31 is able to input the operation-related information Oi, the posture-related information Pi, the suspended-load-related information Li, the hoisting-competency-related information Si1, the movement-competency-related information Si2, and the lowering-competency-related information Si3 from the server S2 via the communication line L.

The control device 31 is able to output the operation-related information Oi, the posture-related information Pi, and the suspended-load-related information Li to the server S2.

The server S2 is able to store the operation-related information Oi, the posture-related information Pi, the suspended-load-related information Li, the hoisting-competency-related information Si1, the movement-competency-related information Si2, and the lowering-competency-related information Si3.

It is possible to electrically couple a plurality of the cranes 1B to the competency-related information generation model 32 in the server S2 via the communication line L. That is, the plurality of cranes 1B share the competency-related information generation model 32 in the server S2.

The competency-related information generation model 32 in the server S2 acquires the operation-related information Oi, the posture-related information Pi, and the suspended-load-related information Li from the plurality of cranes 1B to make it possible to know a difference and a tendency in competency of the operator P operating the crane depending on country, region, belonging group, age, model of the crane, and work content.

In addition, it is possible to cause the competency-related information generation model 32 to undergo machine learning by using the acquired plurality of pieces of the operation-related information Oi, the posture-related information Pi, and the suspended-load-related information Li. As a result, the control device 31 is able to more accurately and appropriately evaluate competency of the operator P by utilizing the competency-related information generation model 32 in the server S2, which is utilized to generate competency-related information of a large number of the operators P.

### Other Embodiments

In the embodiments described above, the cranes 1, 1A, and 1B each evaluate competency of the operator P based on at least one of the hoisting-competency-related information Si1, the movement-competency-related information Si2, and the lowering-competency-related information Si3. However, the cranes may each evaluate competency of the operator by taking into consideration operator-related information related to the operator such as hours of operating the crane of the operator and operation history of the operator.

In addition, the cranes may each evaluate competency of the operator by taking into consideration information of a body of the operator, which relates to the body of the operator, such as heartbeat of the operator. That is, a device for evaluating competency of the operator may evaluate competency of the operator by combining in a desired manner information related to evaluation of competency such as viewpoint-related information in addition to operation-related information, posture-related information, and suspended-load-related information of the operator.

In addition, in the embodiments described above, the cranes 1, 1A, and 1B each evaluate competency of the operator P based on at least one of the hoisting-competency-related information Si1, the movement-competency-related information Si2, and the lowering-competency-related information Si3. However, the cranes may each evaluate competency of the operator, which relates to certain items such as a magnitude of swinging of a suspended load and rotation of the suspended load.

In addition, in each of the embodiments described above, the competency-related information generation model 32 is configured based on a neural network model. However, the competency-related information generation model may be configured based on a machine learning model by using a support vector machine (SVM), a decision tree, a k-nearest neighbor algorithm, a simple Bayesian algorithm, a logistic regression, a linear regression, a nonlinear regression, or a stepwise regression, for example.

In the embodiments described above, the cranes 1, 1A, and 1B each acquire an image of the suspended load W by using the boom camera 9b serving as an imaging device. However, the cranes may each use a camera other than the boom camera as an imaging device. For example, the cranes may each acquire an image captured by an imaging device such as a vehicle body camera of the crane, a camera installed at a construction site, or a camera mounted on a drone.

In addition, in each of the embodiments described above, the competency-related information generation model 32 has undergone machine learning by using, as teacher data, the operation-related information OiL for learning, the posture-related information PiL for learning, and the suspended-load-related information LiL for learning of the operator PL for learning at the advanced level, who corresponds to an expert. However, the competency-related information generation model may have undergone machine learning by using, as teacher information, the operation-related information OiL for learning, the posture-related information PiL for learning, and the suspended-load-related information LiL for learning of the operator PL for learning at the middle level or the basic level, who does not correspond to an expert.

In addition, in each of the embodiments described above, the competency-related information generation model 32 is utilized to generate at least one of the hoisting-competency-related information Si1, the movement-competency-related information Si2, and the lowering-competency-related information Si3 based on the operation-related information Oi, the posture-related information Pi, and the suspended-load-related information Li of the operator P. However, the competency-related information generation model may generate at least one of hoisting-competency-related information, movement-competency-related information, and lowering-competency-related information, including environment-related information that is information related to an environment of the crane when operation-related information, posture-related information, and suspended-load-related information are recorded.

In the embodiments described above, the cranes 1, 1A, and 1B each limit, in accordance with competency of the operator P, a maximum number of rotations of the hydraulic pump 4, an amount of change in number of rotations per unit operation amount Ov of the hydraulic pump 4, a maximum movement speed of each hydraulic actuator, an amount of change in movement speed per unit operation amount Ov of each hydraulic actuator, and an amount of change in movement speed per unit time of each hydraulic actuator. However, it may be sufficient that the cranes each limit numerical values related to characteristics of movement of the hydraulic pump and each hydraulic actuator, such as maximum outputs, average outputs, and ranges of movement of the hydraulic pump and each hydraulic actuator.

In the embodiments described above, the cranes 1, 1A, and 1B each limit, in accordance with competency of the operator P, a maximum number of rotations of the hydraulic pump 4, an amount of change in number of rotations per unit operation amount Ov of the hydraulic pump 4, a maximum movement speed of each hydraulic actuator, an amount of change in movement speed per unit operation amount Ov of each hydraulic actuator, and an amount of change in movement speed per unit time of each hydraulic actuator. At this time, the cranes may each limit at least one of the items for the hydraulic pump and each hydraulic actuator.

In addition, in the embodiments described above, the cranes 1, 1A, and 1B each limit, in accordance with competency of the operator P, at least one of a maximum movement speed, an amount of change in movement speed per unit operation amount Ov, and an amount of change in movement speed per unit time for each of the hydraulic motor 7a for slewing, the hydraulic cylinder 9a for telescopic movement, the hydraulic cylinder 12 for derricking, the main winch 13, and the sub winch 15. However, the cranes may each limit at least one of a maximum movement speed, an amount of change in movement speed per unit operation amount, and an amount of change in movement speed per unit time for at least one of the hydraulic motor for slewing, the hydraulic cylinder for telescopic movement, the hydraulic cylinder for derricking, the main winch, and the sub winch.

The embodiments described above are mere representative forms, and it is possible to apply various types of modifications without departing from the gist of each of an embodiments. It is obvious that it is possible to further implement the present invention in various types of forms, the scope of the present invention is defined as described in the claims, and, furthermore, the present invention includes equivalent meanings described in the claims and all modifications falling within the scope.

### Supplementary Notes

One aspect of a crane when the crane according to the present invention is viewed from another viewpoint will now be described herein. A crane includes: a turning body that is able to turn; a telescopic boom that is able to be raised and lowered and extended and contracted and that is provided on the turning body; a winch that winds and unwinds a wire rope supported on the telescopic boom; a plurality of operation implements for operating each of the turning body, the telescopic boom, and the winch; and a control device that generates a control signal for an actuator for allowing each of the turning body, the telescopic boom, and the winch to operate.

In the crane as described above, the control device limits movement of each of the actuators that allow the turning body, the telescopic boom, and the winch to operate based on at least one of hoisting-competency-related information that is information related to competency when the operator hoists a suspended load from a first position by using the crane, movement-competency-related information that is information related to competency when the operator moves the suspended load positioned above the first position to a position above a second position by using the crane, and lowering-competency-related information that is information related to competency when the operator lowers the suspended load positioned above the second position at the second position by using the crane.

Based on at least one of the hoisting-competency-related information, the movement-competency-related information, and the lowering-competency-related information, which are information related to competency of the operator, the control device of the crane described above limits ability and performance of each actuator such as a movement position, a movement speed, a degree of acceleration of movement, and an output of each actuator, which are regarded as movement of each actuator of the crane. When it is evaluated that competency of the operator is at the advanced level corresponding to an expert, the control device generates a control signal for each actuator without limiting movement of each actuator such as the turning table, the telescopic boom, and the winch. That is, when the crane is operated by an operator at the advanced level, the crane is configured to be operable in accordance with an operation of an operation implement without limiting movement of each actuator. On the other hand, for example, when it is evaluated that competency of the operator is at the basic level, the control device generates a control signal for each actuator in which a maximum speed, maximum torque, and an amount of change with respect to a unit operation amount of an operation implement, for example, of each actuator are limited. That is, when the crane is operated by an operator at the basic level, the crane is configured to be operable in a state where a maximum speed, maximum torque, and an amount of change with respect to a unit operation amount of an operation implement, for example, of each actuator are limited to values for the basic level. That is, the crane adjusts movement of the actuators to allow each actuator to operate within a range allowing the operator to perform, with own competency, an operation with margin and a psychological state. As a result, an operation is able to be performed within a range in which it is possible to reduce a psychological and physical burden on the operator when the operator operates the crane, based on appropriately evaluated competency of the operator.

In addition, the crane as described above preferably includes such a configuration as described below. Each of the actuators that allow the turning body, the telescopic boom, and the winch of the crane to operate includes a hydraulic actuator. The crane includes a hydraulic pump that supplies hydraulic oil to the hydraulic actuator. The control device limits at least one of a maximum number of rotations of the hydraulic pump and an amount of change in number of rotations of the hydraulic pump per unit operation amount of an operation implement for operating the hydraulic pump based on competency-related information.

In the configuration described above, when it is evaluated that competency of the operator is at the basic level based on the hoisting-competency-related information, the movement-competency-related information, and the lowering-competency-related information, the control device of the crane changes at least one of a maximum number of rotations of the hydraulic pump and an amount of change in number of rotations per unit operation amount of the operation implement for operating the hydraulic pump to a value corresponding to that for a beginner. That is, in the crane, at least one of a maximum number of rotations of the hydraulic pump and an amount of change in number of rotations of the hydraulic pump per unit operation amount of the accelerator pedal for operating the hydraulic pump is limited in accordance with competency of the operator. For example, the crane is configured to prevent the hydraulic pump from being operated at a maximum number of rotations and an amount of change in number of rotations or greater, which are limited even when the accelerator pedal is greatly depressed by the operator at the basic level. That is, the crane adjusts movement of the hydraulic pump to allow each actuator to operate within a range allowing the operator to perform, with own competency, an operation with margin and a psychological state. As described above, an operation is able to be performed within a range in which it is possible to reduce a psychological and physical burden on the operator when the operator operates the crane, based on appropriately evaluated competency of the operator.

In addition, the crane as described above preferably includes such a configuration as described below. The control device limits, based on the competency-related information, at least one of a maximum movement speed of at least one of the actuators that allow the turning body, the telescopic boom, and the winch to operate and an amount of change in movement speed of the actuator per unit operation amount of an operation implement for operating the actuator.

In the configuration described above, when it is evaluated that competency of the operator is at the basic level based on the hoisting-competency-related information, the movement-competency-related information, and the lowering-competency-related information, the control device of the crane changes at least one of a maximum movement speed of each of the actuators that allow the turning body, the telescopic boom, and the winch to operate and an amount of change in speed of the actuator per unit operation amount of an operation implement for operating the actuator to a value corresponding to that for the basic level. That is, the crane limits, in accordance with competency of the operator, at least one of a maximum movement speed of an actuator and an amount of change in speed of the actuator per unit operation amount of an operation implement for operating the actuator. For example, the crane is configured to prevent an actuator from being operated at a maximum number of rotations and an amount of change in number of rotations or greater, which are limited even when an operation implement is greatly operated by the operator at the basic level. That is, the crane adjusts movement of the hydraulic pump to allow the turning body, the telescopic boom, and the winch to each operate within a range allowing the operator to perform, with own competency, an operation with margin and a psychological state. As described above, an operation is able to be performed within a range in which it is possible to reduce a psychological and physical burden on the operator when the operator operates the crane, based on appropriately evaluated competency of the operator.

In addition, the crane as described above preferably includes such a configuration as described below. The control device limits, based on competency of the operator, an amount of change in speed per unit time of each of the actuators that allow the turning body, the telescopic boom, and the winch to operate.

In the configuration described above, when it is determined that competency of the operator is at the basic level based on the hoisting-competency-related information, the movement-competency-related information, and the lowering-competency-related information, the control device of the crane changes an amount of change in speed per unit time of each of the actuators that allow the turning body, the telescopic boom, and the winch to operate to a value corresponding to that for the basic level. That is, in the crane, an amount of change in speed per unit time of an actuator is limited in accordance with competency of the operator. The crane is configured to prevent a movable portion of an actuator from being operated at an amount of change in speed for the basic level or higher even when an operation implement is suddenly operated by the operator regarded as a beginner. As described above, an operation is able to be performed within a range in which it is possible to reduce a psychological and physical burden on the operator when the operator operates the crane, based on appropriately evaluated competency of the operator.

In addition, the crane as described above preferably includes such a configuration as described below. The control device of the crane includes: a storage unit that stores operation-related information that is information related to an operation of an operation implement by the operator in work for transporting a suspended load from a first position to a second position, posture-related information that is information related to a posture of the crane, and suspended-load-related information that is information related to the suspended load transported by the crane; and a competency-related information generation model that generates at least one of hoisting-competency-related information, movement-competency-related information, and lowering-competency-related information based on at least one of the operation-related information, the posture-related information, and the suspended-load-related information. By utilizing the competency-related information generation model, the control device generates at least one of the hoisting-competency-related information, the movement-competency-related information, and the lowering-competency-related information based on the operation-related information, the posture-related information, and the suspended-load-related information, which are stored in the storage unit.

In the configuration described above, by utilizing the competency-related information generation model, the control device of the crane generates the hoisting-competency-related information, the movement-competency-related information, and the lowering-competency-related information based on the operation-related information, the posture-related information, and the suspended-load-related information. Furthermore, the control device evaluates competency of the operator based on the competency-related information. As at least one of operation-related information, posture-related information, and suspended-load-related information is to be generated, the control device is able to appropriately evaluate competency of the operator in each of steps including a hoisting step for a suspended load, a transport step for the suspended load, and a grounding step for the suspended load, which require different competency in handling of the suspended load. As described above, an operation is able to be performed within a range in which it is possible to reduce a psychological and physical burden on the operator when the operator operates the crane, based on appropriately evaluated competency of the operator.

In addition, the crane as described above preferably includes such a configuration as described below. The operation-related information includes information related to the viewpoint of the operator when the operator operates the crane.

In the configuration described above, the control device of the crane further evaluates competency of the operator by using information related to the viewpoint of the operator, which is included in the operation-related information. It is known that thought, emotion, and a psychological state of the operator indirectly appear in information related to the viewpoint of the operator. That is, the control device appropriately evaluates competency of the operator by taking into consideration the thought, the emotion, and the psychological state of the operator. As described above, an operation is able to be performed within a range in which it is possible to reduce a psychological and physical burden on the operator when the operator operates the crane, based on appropriately evaluated competency of the operator.

In addition, the crane as described above preferably includes such a configuration as described below. The competency-related information generation model is a machine learning model having undergone machine learning by using, as teacher information, the operation-related information, the posture-related information, and the suspended-load-related information of an operator who corresponds to an expert having higher competency of maneuvering the crane than the threshold value, among operators of cranes.

In the configuration described above, the control device of the crane is able to evaluate competency of the operator as a degree of proficiency based on competency of an operator at the advanced level as an index by utilizing the competency-related information generation model having undergone machine learning by using, as teacher information, the operation-related information of the operator at the advanced level, the posture-related information, and the suspended-load-related information.

As described above, an operation is able to be performed within a range in which it is possible to reduce a psychological and physical burden on the operator when the operator operates the crane, based on appropriately evaluated competency of the operator.

In addition, the crane as described above preferably includes such a configuration as described below. The competency-related information generation model is positioned in the server that is able to be coupled to the control device by using the communication line. The control device generates competency-related information of the operator based on the operation-related information, the posture-related information, and the suspended-load-related information, which are stored in the storage unit, by utilizing the competency-related information generation model in the server.

The control device of the crane evaluates competency of the operator by utilizing the competency-related information generation model positioned in the external server. The control device is able to more accurately and appropriately evaluate competency of the operator by utilizing the competency-related information generation model in the server, which is utilized to generate competency-related information of a large number of operators. As described above, an operation is able to be performed within a range in which it is possible to reduce a psychological and physical burden on the operator when the operator operates the crane, based on appropriately evaluated competency of the operator.

This application is based upon and claims the benefit of priority from Japanese Patent Application No. 2022-168391, filed on Oct. 20, 2022, the entire contents of which are incorporated herein by reference.

The present invention can be applied to various cranes.

### REFERENCE SIGNS LIST

1, 1A, 1B Crane
2 Vehicle
3 Engine
4 Hydraulic pump
5 Outrigger
6 Crane apparatus
7 Turning table
7a Hydraulic motor for slewing
8 GNSS receiver for crane
9 Telescopic boom
9a Hydraulic cylinder for telescopic movement
9b Boom camera
9c Jib
10 Main hook block
10a Main hook
11 Sub hook block
11a Sub hook
12 Hydraulic cylinder for derricking
13 Main winch
14 Main wire rope
15 Sub winch
16 Sub wire rope
17 Cabin
18 Operation implement for traveling
18a Accelerator pedal
19 Operation implement for crane apparatus
19a Operation implement for slewing
19b Operation implement for telescopic movement
19c Operation implement for derricking
19d Operation implement for main winch
19e Operation implement for sub winch
20 Input device
21, 31 Control device
21a Communication device
32 Competency-related information generation model
33 Storage unit
34 Display device
35 Viewpoint detection device
Oi Operation-related information
OiL Operation-related information for learning
Pi Posture-related information
PiL Posture-related information for learning
Li Suspended-load-related information
LiL Suspended-load-related information for learning
Vi Viewpoint-related information
Si1 Hoisting-competency-related information
Si2 Movement-competency-related information
Si3 Lowering-competency-related information
W Suspended load
Pv Viewpoint detection image
Pw Image of suspended load
P Operator
S1, S2 Server
T1, T2, T3 Competency
Rv1, Rv2, Rv3 Number of rotations
Ra1, Ra2, Ra3 Amount of change in number of rotations
Mv1, Mv2, Mv3 Movement speed
Ma1, Ma2, Ma3 Amount of change in movement speed
Mam1, Mam2, Mam3 Amount of change in movement speed per unit time
Ov Unit operation amount
X1 Hoisting step
X2 Grounding step
Y1 Transport step
L Communication line

1. A crane comprising:
a turning body;
a boom that is supported by the turning body;
a winch that winds and unwinds a wire rope supported on the boom; and
a control device that controls the turning body, the boom, and the winch,
wherein the control device limits movement of the turning body, the boom, and the winch based on competency-related information indicating competency of an operator, the competency being related to at least one type of work from among work for hoisting a suspended load, work for horizontally transporting the suspended load, and work for lowering the suspended load.

2. The crane according to claim 1, further comprising:
actuators that allow the turning body, the boom, and the winch to operate; and
a hydraulic pump that supplies hydraulic oil to the actuators,
wherein the control device limits, based on the competency-related information, at least one of a maximum number of rotations of the hydraulic pump and an amount of change in number of rotations of the hydraulic pump per unit operation amount of an operation implement for operating the hydraulic pump.

3. The crane according to claim 1, wherein
the control device limits, based on the competency-related information, at least one of a maximum movement speed of a target actuator that is at least one of: the actuators that allow the turning body, the boom, and the winch to operate; and an amount of change in movement speed of the target actuator per unit operation amount of an operation implement for operating the target actuator.

4. The crane according to claim 1, wherein
the control device limits, based on the competency-related information, an amount of change in speed per unit time of each of the actuators that allow the turning body, the boom, and the winch to operate.

5. The crane according to claim 1, wherein
the control device further includes a storage unit and a competency-related information generation model,
the storage unit
stores operation-related information that is information related to an operation of an operation implement by the operator in work for transporting the suspended load from a first position to a second position, posture-related information that is information related to a posture of the crane, and suspended-load-related information that is information related to the suspended load transported by the crane, and
the competency-related information generation model generates, based on the operation-related information, the posture-related information, and the suspended-load-related information, at least one of hoisting-competency-related information indicating competency of the operator related to work for hoisting the suspended load, movement-competency-related information indicating competency of the operator related to work for horizontally transporting the suspended load, and lowering-competency-related information indicating competency of the operator related to work for lowering the suspended load of the operator.

6. The crane according to claim 5, wherein
the operation-related information includes information related to a viewpoint of the operator while the operator operates the crane.

7. The crane according to claim 5, wherein
the competency-related information generation model is a machine learning model having undergone machine learning by using, as teacher information, the operation-related information, the posture-related information, and the suspended-load-related information of a proficient operator having competency of maneuvering the crane, the competency being higher than a threshold value.

8. The crane according to claim 5, wherein
the competency-related information generation model is provided in a server connectable to the control device by using a communication line, and
the control device uses the competency-related information generation model in the server to generate the competency-related information of the operator.
